(19) United States
(12) Patent Application Publication
(10) Pub. No.: US 2025/0173947 A1
(43) Pub. Date: May 29, 2025

(54) SIGNALING VOLUMETRIC VISUAL VIDEO-BASED CODING CONTENT IN IMMERSIVE SCENE DESCRIPTIONS

(71) Applicant: InterDigital VC Holdings, Inc., Wilmington, DE (US)

(72) Inventors: Ahmed Hamza, Coquitlam (CA); Gurdeep Bhullar, Montreal (CA)

(73) Assignee: InterDigital VC Holdings, Inc., Wilmington, DE (US)

(21) Appl. No.: 18/728,987

(22) PCT Filed: Jan. 17, 2023
(86) PCT No.: PCT/US2023/010955

§ 371 Date: Jul. 15, 2024

Related U.S. Application Data
(60) Provisional application No. 63/299,874, filed on Jan. 14, 2022.
(60) Provisional application No. 63/355,936, filed on Jun. 27, 2022.
(60) Provisional application No. 63/417,225, filed on Oct. 18, 2022.
(60) Provisional application No. 63/417,967, filed on Oct. 20, 2022.

(51) Int. Cl. G06T 15/00; G06T 1/20; G06T 11/00; H04N 19/597

(52) U.S. Cl. CPC G06T 15/005; G06T 1/20; G06T 11/001; G06T 2210/61; H04N 19/597

(57) ABSTRACT

The present system and method are directed to volumetric video representation in a scene description. The described systems and methods present a generic design to support V3C/V-PCC content. The systems and methods include the semantics as well as binary representation for decoded V3C/V-PCC media data in the form of buffers which may be used by the presentation engine for reconstruction and rendering.

### CROSS-REFERENCE TO RELATED APPLICATIONS

This application claims the benefit of U.S. Provisional Application No. 63/299,874, filed Jan. 14, 2022; U.S. Provisional Application No. 63/326,628, filed Apr. 1, 2022; U.S. Provisional Application No. 63/355,936, filed Jun. 27, 2022; U.S. Provisional Application No. 63/417,225, filed Oct. 18, 2022; and U.S. Provisional Application No. 63/417,967, filed Oct. 20, 2022, the contents of which are incorporated herein by reference.

### BACKGROUND

A rendering/presentation engine may be used to compose and render a scene. The information used to compose and render the scene may be provided by a scene description. The Moving Picture Experts Group (MPEG) has incorporated glTF as a scene graph format and extended glTF to support dynamic (timed) content such as 2D and 360-degree videos, dynamic volumetric visual media, and audio. Additional support for volumetric visual media in glTF via extensions may be desired.

An Exploration Experiment (EE) has been initiated to support MPEG immersive codecs in MPEG scene descriptions. This EE is oriented to architect design principles and workflows for immersive media coded content using MPEG technologies such as video-based point cloud compression (V-PCC), geometry-based point cloud compression (G-PCC), and MPEG immersive media (MIV). Efforts to specify how to playback volumetric visual media that is part of a glTF scene are on-going. Two different approaches have been studied as technologies under consideration to support volumetric visual video-based coding (V3C) content. However, these approaches are limiting and do not scale to different types of V3C coded content.

### SUMMARY

The present systems and methods are directed to volumetric video representation in a scene description. The described systems and methods present a generic design to support V3C/V-PCC content. The systems and methods include the semantics as well as binary representation for decoded V3C/V-PCC media data in the form of buffers which may be used by the presentation engine for composition/reconstruction and rendering of a scene.

A glTF extension to support and allow the usage of YCbCr texture formats in MPEG-I scene description. The extension enlists the properties of a YCbCr texture. A process is described such that appropriate shader implementation or native GPU implementation can use the information in the extension. The extension adapts the description of YCbCr texture which is used in modern graphics APIs such as Vulkan.

A glTF extension to support timed 3D videos in MPEG-I Scene description which are coded using V3C (ISO/IEC 23090-5) technique. Such timed 3D videos could be V-PCC (as listed in ISO/IEC 23090-5) and MIV (ISO/IEC 23090-12).

A semantical mechanism is introduced by which the decoded V3C components are represented in MPEG-I Scene description. Each V3C component is represented as a JSON literal under the glTF extension. Some of the components have specific properties which are further described in the respective component i.e. V3C Attribute component, and V3C Atlas component. Furthermore, a processing methodology for the presentation engine is described which utilizes the information stored under glTF extension.

Buffer formats for decoded atlas data provides the relevant information to reconstruct 3D video's representation from decoded 2D video streams. The buffer formats can be of different types where each type provide relevant application-specific information. For MIV specially, the use of common atlas data to include view parameters is also represented as a property in the glTF extension. The buffer format storing the view parameters is exchanged with the presentation engine which enable it to reconstruct different views.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an exemplary MPEG scene description architecture;

FIG. 3 illustrates an example pipeline design to process V-PCC content;

FIG. 4 illustrates an example V3C profile;

FIG. 5 illustrates an example Atlas data representation for patch type PROJECTED and PLR enabled at patch level;

FIG. 6 illustrates multiple accessors accessing different sub-blocks in atlas binary data;

FIG. 7 illustrates an Atlas data representation with contains data for patch type PROJECTED and PLR information is available at block level;

FIG. 8 illustrates the representation of sub-blocks and how to read atlas data; and

FIG. 9 illustrates a method for the media workflow for V3C content.

### DETAILED DESCRIPTION

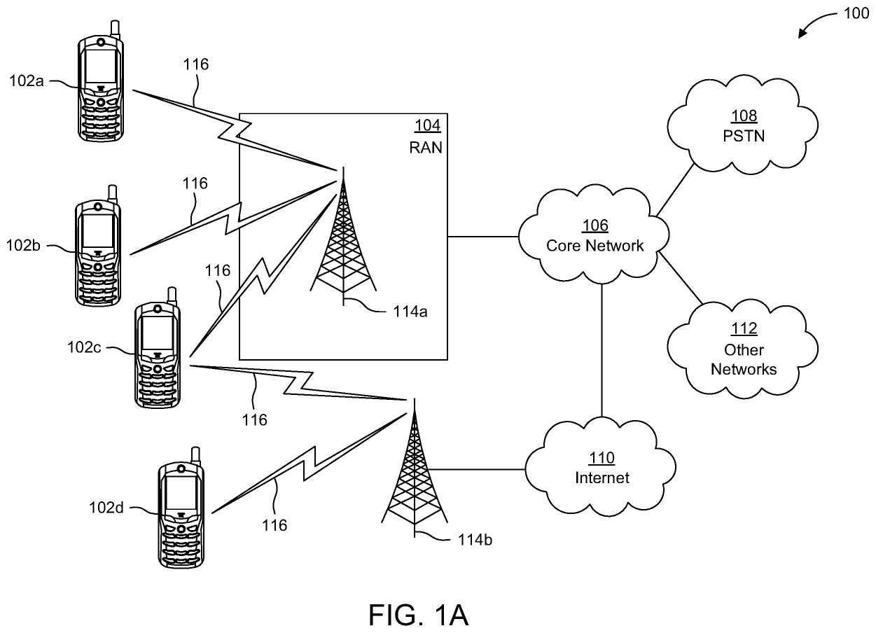

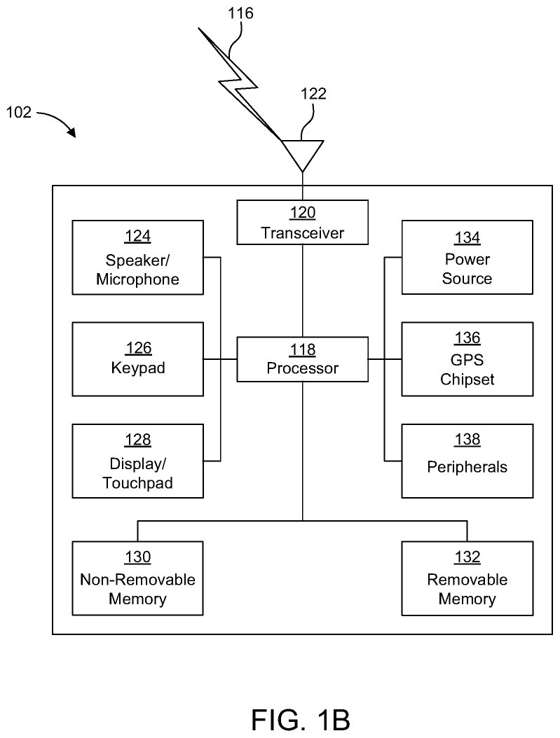

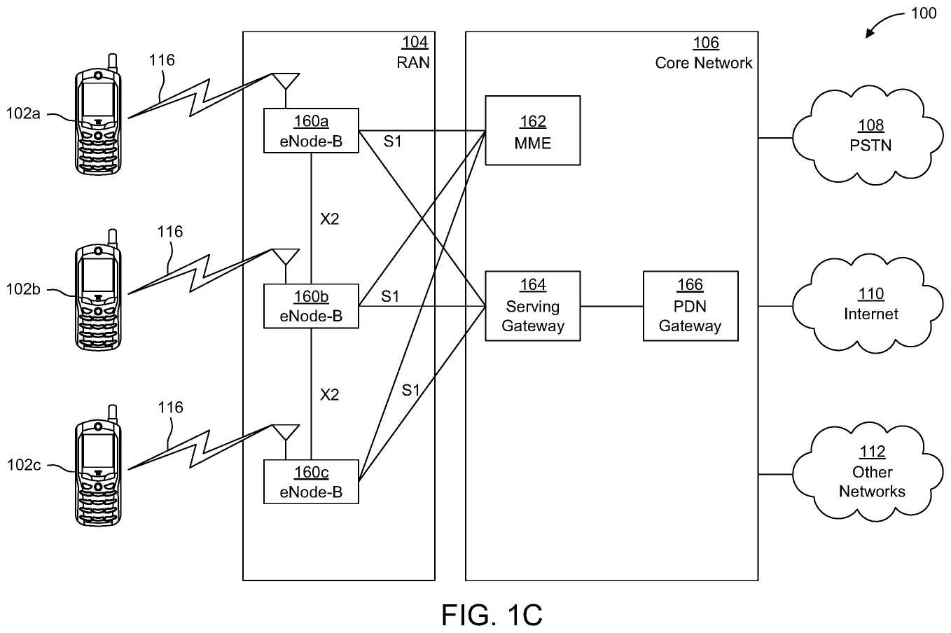

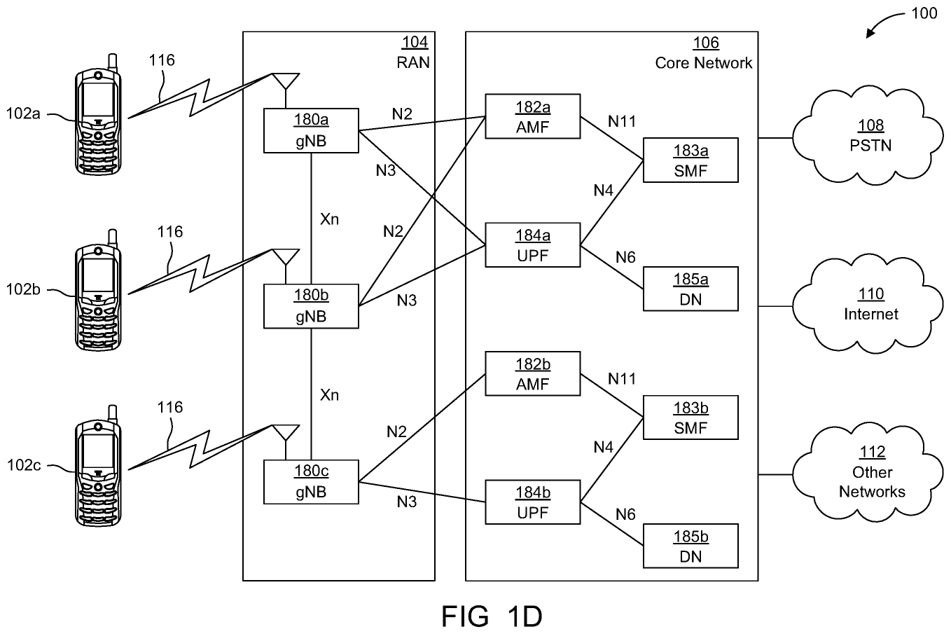

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it may be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it may be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it may be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It may be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it may be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It may be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ

MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It may be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it may be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it may be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it may be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it may be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A rendering/presentation engine (e.g., a game engine such as Unity, Unreal Engine, etc.) may be used to compose and render a scene. The information used to compose and render the scene, generally referred to as scene information, may be provided by a scene description. One of the scene description formats is Khronos' glTF. glTF is a JSON-based file format that provides a mechanism to refer to external binary and image file(s). glTF supports static media objects including some forms of dynamicity using animation. MPEG has generally incorporated glTF as a scene graph format and extended glTF to support dynamic (timed) content such as 2D and 360-degree videos, dynamic volumetric visual media, and audio.

For example, there is development of an international standard ISO/IEC 23090-14 which leverages the glTF specification and defines support for dynamic (timed) media such as 2D videos, volumetric visual media, audio, haptics, and others. The support for dynamic media is enabled using the extension mechanism in glTF. The MPEG-I scene description group in WG3 has started to integrate MPEG-defined media formats such as 2D videos encoded using H.264/AVC (ISO/IEC 14496-10), HEVC (ISO/IEC 23008-2), or VVC (ISO/IEC 23090-3) codecs.

In addition, ways to provide support for volumetric visual media are being explored, as defined in the ISO/IEC 23090-5 and ISO/IEC 23090-9 standards, and in glTF via extensions. An Exploration Experiment (EE) has been initiated to support MPEG immersive codecs in MPEG scene description. The EE is to architect design principles and workflows for immersive media coded content using MPEG technologies, such as video-based point cloud compression (V-PCC), geometry-based point cloud compression (G-PCC), and MPEG immersive media (MIV). In the latest draft of ISO/IEC 23090-14, there are ongoing efforts to specify how to playback volumetric visual media that is part of a glTF scene. Currently, two different approaches have been studied as technologies under consideration to support volumetric visual video-based coding (V3C) content. However, these approaches are limiting and do not scale to different types of V3C coded content.

Content encoded using a V3C codec are composed of several V3C components. These components include several video-coded information (e.g., geometry, occupancy, and attributes) and an atlas metadata stream that enable the reconstruction of the volumetric media frames using the video-coded information. The frames for the video-coded components follow a structure described by the atlas patch information. Each atlas frame may be subdivided into atlas tiles. An atlas tile may contain multiple patches. Each patch may contain additional information and each patch can be of different type. For example, in case of PROJECTED type, each patch may provide Point Local Reconstruction (PLR) information either on block level or patch level, while each attribute video stream is of one attribute type only.

A glTF extension to support and allow the usage of YCbCr texture formats in MPEG-I scene description. The extension enlists the properties of a YCbCr texture. A process is described such that appropriate shader implementation or native GPU implementation can use the information in the extension.

The extension adapts the description of YCbCr texture which is used in modern graphics APIs such as Vulkan.

A glTF extension to support timed 3D videos in MPEG-I Scene description which are coded using V3C (ISO/IEC 23090-5) technique. Such timed 3D videos could be V-PCC (as listed in ISO/IEC 23090-5) and MIV (ISO/IEC 23090-12).

A semantical mechanism is introduced by which the decoded V3C components are represented in MPEG-I Scene description. Each V3C component is represented as a JSON literal under the glTF extension. Some of the components have specific properties which are further described in the respective component i.e. V3C Attribute component, and V3C Atlas component. Furthermore, a processing methodology for the presentation engine is described which utilizes the information stored under glTF extension.

Buffer formats for decoded atlas data provides the relevant information to reconstruct 3D video's representation from decoded 2D video streams. The buffer formats can be of different types where each type provide relevant application-specific information. For MIV specially, the use of common atlas data to include view parameters is also represented as a property in the glTF extension. The buffer format storing the view parameters is exchanged with the presentation engine which enable it to reconstruct different views.

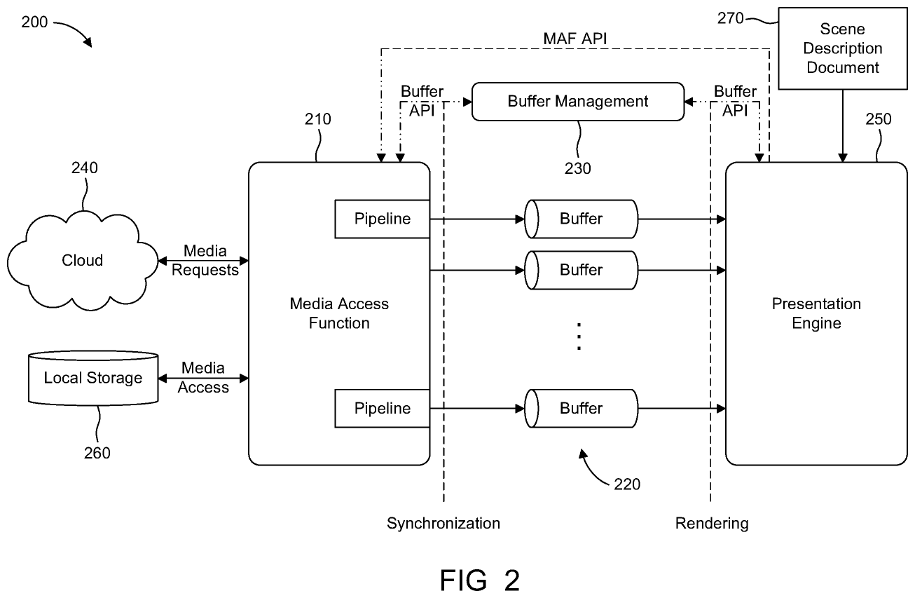

FIG. 2 illustrates an exemplary MPEG scene description architecture 200. There are two main entities in the MPEG-I scene description architecture 200: the media access function (MAF) 210 and the presentation engine (PE) 250. The foundational consideration for the reference architecture 200 is to decouple the functionality of the MAF 210 from the rendering and presentation of PE 250. MAF 210 is responsible for requesting, fetching, decoding, and post-processing the media data required by the PE 250 to render the various media objects that are part of the scene. MAF 210 is expected to present the media data in appropriate buffer formats in accordance with the scene description document 270 such that they are readable by PE 250. The scene description document 270 is loaded by PE 250 and scene description document 270 identifies from the relevant buffers for each media object in the scene and their formats.

MAF 210 communicates with cloud 240 to request media. These media requests may occur in either direction. MAF 210 communicates with local storage 260 to gain access to media. These media access may occur in either direction. MAF 210 builds the media pipeline for rendering and uses a series of buffers 220 to do so. Buffer management 230 is configured to operate between the PE 250 and MAF 210 to provide media that is synchronized for rending. PE 250 receives the media in a synchronized form from the MAF 210 via buffers 220 controlled by buffer management 230 and renders the scene.

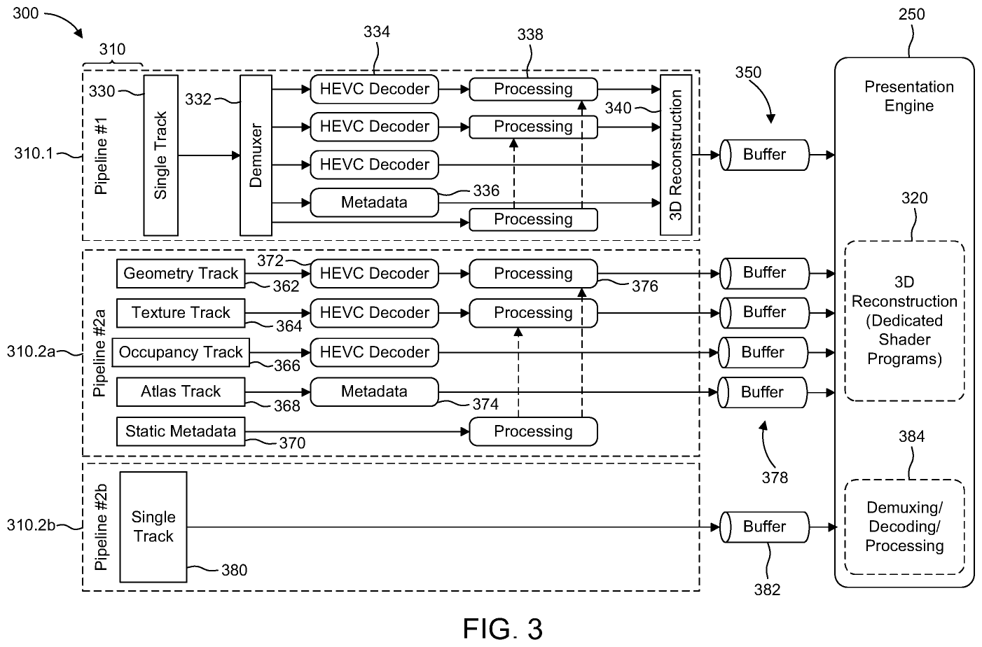

FIG. 3 illustrates an example pipeline design 300 to process V-PCC content. In identifying appropriate media pipelines and relevant formats for each media type to be supported the example pipeline design 300 may be used. Different potential media pipelines may be constructed to process the media differently depending on the specific use case and therefore each media pipeline may have different output buffer formats. One of the potential pipeline designs for processing V3C/V-PCC media is shown in FIG. 3 (pipeline #2A 310.2a). In this pipeline 310.2a, the decoding and post-processing steps for a V3C/V-PCC coded content provide the processed data in well-defined buffers to PE 250 for 3D reconstruction. Dedicated shader programs 320 may be utilized by PE 250 to perform 3D reconstruction when using the workflow of Pipeline #2A 310.2a. The shader programs may be loaded to GPU hardware resources, resulting in efficient and real-time playback of the volumetric visual media content.

In FIG. 3A, a pipeline #1 310.1 is illustrated. Pipeline #1 310.1 includes a single track 330 that supplies a demuxer 332. Pipeline #1 310.1 then includes a series of HEVC decoders 334 and metadata 336. Pipeline #1 310.1 continues with a series of processing 338 that feeds 3D reconstruction 340. Pipeline #1 310.1 then is buffered 350 and provides signal to PE 250.

In FIG. 3, a pipeline #2a 310.2a is illustrated. Pipeline #2a 310.2a includes a geometry track 362, a texture track 364, an occupancy track 366, an atlas track 368, and a static metadata 370. These tracks are in place of the single track 330 that supplies a demuxer 332 in pipeline #1 310.1. Pipeline #2a 310.2a then includes a series of HEVC decoders 372 and metadata 374. These series of HEVC decoders 372 and metadata 374 may be similar to series of HEVC decoders 334 and metadata 336. Instead of performing the reconstruction in pipeline #2a 310.2a like pipeline #1 310.1 at 3D reconstructions 340, pipeline #2a 310.2a instead is buffered in a series of buffers 378 (described herein) and the 3D reconstructions 320 occurs in the PE 250 as described above.

In FIG. 3, pipeline #2b includes a single track 380 that is buffered 382 and fed to PE250. Demultiplexing/decoding/processing 384 may be performed on the signals within PE 250.

To support the use of such a workflow, the formats for the buffers for each V3C/V-PCC content are defined. Moreover, the processing steps may perform all the operations to represent the data in the well-defined buffer formats. A scene description document must therefore provide the information related to the buffers.

To support timed-data access, the buffer element in ISO/IEC DIS 12113:2021 is extended to provide the functionality of a circular buffer. The extension is named MPEG_buffer_circular and may be included as part of the “buffers” structures. Buffers that provide access to timed data may include the MPEG_buffer_circular extension.

When MPEG_buffer_circular extension is present in a buffer element, the buffer element property uri may not be present and the buffer element property byteLength may indicate the maximum possible size of the buffer. When present, the MPEG_buffer_circular extension may be included as extension of a buffer object defined in ISO/IEC DIS 12113:2021.

An accessor as specified in ISO/IEC DIS 12113:2021 defines the types and layout of the data as stored in a buffer that is viewed through a bufferView object. When timed-media is read from a buffer, the data in the buffer may change dynamically with time.

The timed-accessor extension enables access to dynamically changing data used in a scene. The timed accessor is an extension to regular glTF accessors to indicate that the underlying data buffer is dynamic. A timed-accessor may have two buffer views, one inherited from the containing accessor and a second in the MPEG_accessor_timed extension. The former may be used to reference the timed-media data while the latter may be used to point to a dynamic buffer header, which may or may not be present. When present, both bufferViews may point into the same circular buffer. Accessors that include the MPEG_accessor_timed extension may only point to buffers that include the MPEG_buffer_circular extension as described herein.

The accessor.bufferView field, in an accessor that has the MPEG_accessor_timed extension, as well as the timed-accessor information header fields apply to the data of each frame within the circular buffer. The timed-accessor extension is identified by an MPEG_accessor_timed element. When present, the MPEG_accessor_timed extension may be included as extension of an accessor object defined in ISO/IEC DIS 12113:2021. This extension, identified by an MPEG_texture_video element, provides the possibility to link a texture object defined in ISO/IEC DIS 12113:2021 to a video source. The MPEG_texture_video extension provides a reference to a timed-accessor, i.e., an accessor with the MPEG_accessor_timed extension, where the decoded texture frames may be made available. When present, the MPEG_texture_video extension may be included as extension of a texture element defined in ISO/IEC DIS 12113:2021. When the MPEG_texture_video extension is not supported, the standard glTF texture may be used as fallback.

The MPEG_texture_video extension includes an accessor property which provides a reference to the accessor, by specifying an index of a particular accessor object in an accessors array which describes the buffer where the decoded timed-texture may be made available. The MPEG_texture_video extension also provides information about the format of the video texture through a format property. The type, componentType, and count properties of the accessor depend on the width, height, and format properties.

A media pipeline is a chain of media processing components to process media. A media pipeline is specific to a media content. Patch packing block size is a unit expressing the 2D placement of patches within the atlas.

Multiple atlases may be included in a V3C bitstream. A V3C bitstream may be demultiplexed into one or more atlas bitstreams, if multiple atlases are present, and their associated video bitstreams. Video bitstreams for each atlas may include occupancy, geometry, and attribute components. In V3C parameter set, vps_atlas_count_minus1 plus 1 indicates the total number of supported atlases in the current bitstream. The value of vps_atlas_count_minus1 may be in the range of 0 to 63, inclusive. vps_atlas_id specifies the ID of the atlas. The value of vps_atlas_id may be in the range of 0 to 63, inclusive.

A V3C bitstream is multiplexed into one or more atlas sub-bitstreams, if multiple atlases are present, and the associated video sub-bitstreams. The video sub-bitstreams for each atlas may include video-coded occupancy, geometry, and attribute components. An atlas sub-bitstream is decoded using an atlas decoder (a hypothetical reference atlas decoder is defined in Annex E of ISO/IEC 23090-5).

An atlas decoder parses the atlas sub-bitstream to decode the atlas NAL units and atlas tile headers. An atlas frame may be sub-divided into tiles. Each atlas tile is independently decodable and facilitate implementations to perform efficient processing such as parallel processing. Each tile may contain different number of patches. A patch stores information such as mapping information from 2D to 3D space, patch type, etc. After decoding the patches present within an atlas tile, a mapping between the block to patch is created which assigns each block that overlaps a patch with a patch index relative to the atlas tile in which the patch is contained (see subclause 9.2.6 of ISO/IEC 23090-5). The blocks are indexed per patch per tile.

In a V3C sequence, it is expected that the number of total patches as well as the number of tiles may change over time. Therefore, it is not possible to provide deterministic information related to patches with respect to the tile that patches belong to. Rather, tile-level patch information is converted to atlas frame-level patch information. Since the atlas frame is a constant, i.e., the size of the atlas frame does not change in a V3C sequence.

The V3C specification provides a method to convert tile-level patch information to atlas-level patch information (subclause 9.2.7 of ISO/IEC 23090-5). The operations defined in subclause 9.2.7 of ISO/IEC 23090-5 convert the patch information (e.g., 2D location of a patch, patch dimensions, etc.) so that the relative to the atlas frame instead of a certain tile.

For example, subclause 9.2.7.2 in ISO/IEC 23090-5, provides information on how to convert a tile-level block-to-patch map to an atlas-level block-to-patch map. Such a mapping creates a list of total patches contained in an atlas frame. Every block gets assigned a patch index in reference to the atlas frame (some blocks may not overlap with any patch; such blocks are indexed with −1). This operation removes the notion of tiles in the block ToPatch mapping structure.

To eliminate the notion of tiles in the decoded patch information, operations defined in subclause 9.2.7.3 of ISO/IEC 23090-5 are invoked. These operations translate the patch information which are defined in reference to the tile in which the patch is contained to a global reference with respect to the atlas frame. These operations convert and provide atlas-level patch information such as information that is common for all patches as well as application-specific patch information.

The decoded atlas buffer includes two main structures: a block-to-patch map and a patch list. The block-to-patch map maps each block in an atlas frame to a patch index. In case the block is not covered by any patch, the patch index value assigned to that block is −1. The patch list includes the data for each patch is contained in a patch list. A patch includes two sets of information. Common patch information data and application-specific patch information data. There may be additional information depending on the type of patch e.g., Point Local Reconstruction, EOM points etc., which needs to be stored in the atlas buffer.

Common patch information is applicable through the patch. This includes information (see section 9.2.7.3.2 of ISO/IEC 23090-5) such as: Patch Type; Patch 2D size; Patch position; Patch 3D offset; Patch 3D depth range; Patch projection ID; Patch orientation Index; Level of Details scaling factor; RAW points; and Number of EOM patches. A benefit may be provided when storing the common patches in an order.

Application-specific atlas-level patch information provide more details about each patch type (see sub-clause 9.2.7.3.3 of ISO/IEC 23090-5). For example, when the patch type is PROJECTED, additional information may be required to perform Point Local Reconstruction (PLR) (sub-clause 8.4.7.9 in ISO/IEC 23090-5). Similarly, for other patch types, such as EOM and RAW additional details can be provided.

MPEG immersive video is an extension of V3C specification. MIV describes the concept of views and its mapping to patches in V3C components. A view represents a field of view of a volumetric frame, which may be represented by a one 2D frame providing geometry, plus one 2D frame per attribute. The coded atlas contains information describing the patches within the atlas frame. The coded atlas frame contains the view information for each patch such that 3D points can therefore be expressed according to the reference frame of any view. For each patch, different views are signaled which identifies which view the patch originated from. For each view, there are several parameters.

Application-specific atlas-level patch information is further extended to add view index for each patch in an MIV content.

The video frames provided by the decoder may require additional processing steps before being input to the reconstruction process. The processes described in Annex B in ISO/IEC 23090-5 are invoked for decoded video components associated with the same atlas ID. Different V3C video coded components are processed and subject to different processes. The V3C video-coded components are converted to a nominal format. The nominal format refers collectively to the nominal bit depth, resolution, chroma format, and composition time index that the decoded videos may be converted to. Each video sub-bitstream and each region of packed video sub-bitstream is associated with a nominal bit depth, which is the target bit depth that all operations for reconstruction are expected to be performed in. In ISO/IEC 23090-14, the nominal format is expected to be the 4:4:4 chroma sub-sampling format. The processes may include map extraction, geometric map synthesis, attribute map synthesis, resolution conversion, chroma up-sampling. For details about the processes refer to Annex B in ISO/IEC 23090-5.

Packed video is a flexible syntax that allows to pack multiple components of a V3C bitstream into the same video frame. Multiple V3C video components are contained in the same V3C unit, i.e., V3C_PVD. A V3C_PVD may store video components, such as some, multiple or all the video components, of an atlas (e.g., geometry, occupancy, and attribute video). The V3C syntax may describe the frame packing logic. After the decoding of a packed video, the frame packing logic may be used by the V3C decoder to unpack the various components into separate individual video components streams.

When the vuh_unit_type is equal to V3C_PVD, the decoding process corresponding to the packed video components may be invoked. The information on packed video configuration is provided in the packing information syntax. The packing information syntax may provide the information to unpack the packed video stream.

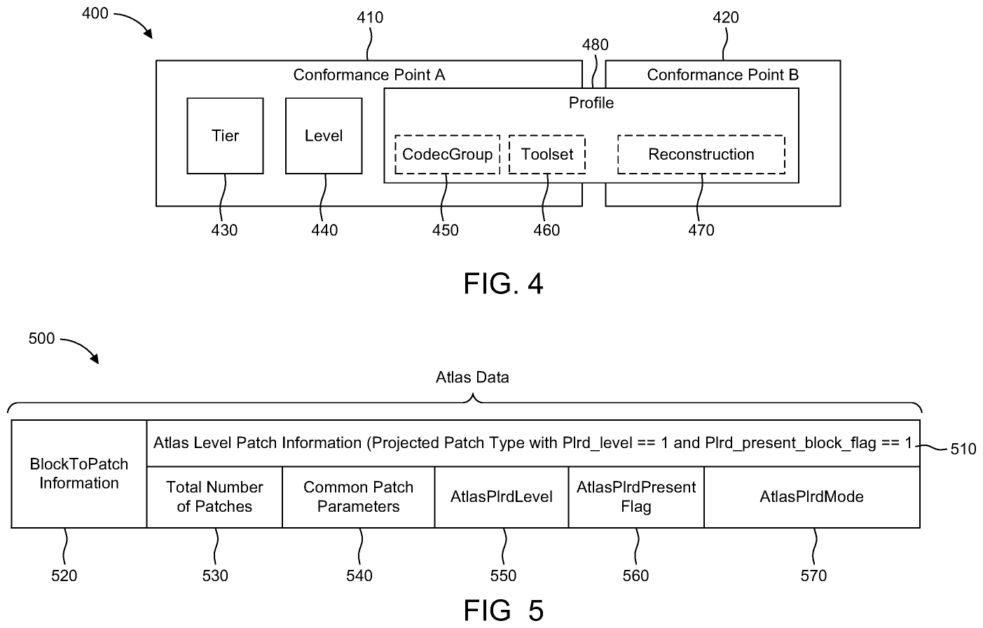

FIG. 4 illustrates an example V3C profile 400. Generally, V3C profiles follow a structured and flexible definition to allow for clearly identifying two distinct conformance points (conformance point A 410 and conformance point B 420). Indicating conformance point A 410 may be mandatory while conformance point B 420 may be optional. A V3C profile 400 decoding capabilities are defined by codec group 450 and toolset 460 which are typically present in the VPS or may be retrieved through external means.

The first conformance point, conformance point A 410, covers the decoded video sub-bitstreams and the atlas sub-bitstream. The first conformance point 410 covers the derived block to patch map information. The first conformance point 410 does not, however, cover the reconstruction process. Any decoder conforming to a V3C profile 400 at conformance point A 410 (identified by syntax elements ptl_profile_codec_group_idc and ptl_profile_toolset_idc) at a specific level 440 (identified by the value of syntax element ptl_level_idc) of a specific tier 430 (identified by the value of syntax element ptl_tier_flag) may be capable of decoding all V3C bitstreams or collection of V3C sub-bitstreams, according to clause A.2 in ISO/IEC 23090-5, which provides details on how profiles 480, toolset 460, tier 430 information are used to decode the V3C media.

The second conformance point, conformance point B 420, covers the reconstruction process. The third V3C profile component, namely reconstruction 470, describes conformance point B 420 and specifies the pre-reconstruction, reconstruction, post-reconstruction, and adaptation tools supported or recommended to achieve conformance in terms of 3D reconstruction.

glTF does not natively support video textures. The MPEG_texture_video extension described hereinabove provides the ability to support a timed-texture. However, when the color space of the information stored in video textures is YUV/YCbCr, appropriate sampler information may be necessary.

Typically, a texture item in a textures array has two properties: sampler and source. The source property provides information about the texture and the sampler property provides information relevant to the sampling operations. A typical syntax of a texture item in the textures array is represented below. The sampler property for a particular texture object in the textures array points to a sampler object in the sampler array and the source property for a texture object points to an image object in the images array.

A typical syntax of a texture item in the textures array:

```
“textures”: [ {
  “sampler”: 0,
  “source”: 0
} ],
“images”: [ {
  “uri”: “testTexture.png”
} ],
“samplers”: [ {
  “magFilter”: 9729,
  “minFilter”: 9987,
  “wrapS”: 33648,
  “wrapT”: 33648
} ],
```

A source of the texture in glTF typically support JPEG (JFIF) and PNG image formats. However, it is left to the implementation to decode the source image files. The decoding process is not expressed in glTF.

In many cases, the data for the source image may be stored as interleaved or planar. There is no support to express the data alignment for the source image in glTF.

The atlas information is specified as a syntax of MPEG_primitive_v3c extension in CDAM1 as illustrated in Table 1.

TABLE 1
Atlas information as a syntax of MPEG_primitive_v3c extension in CDAM1

| Name | Type | Default | Usage | Description |
|---|---|---|---|---|
| _mpeg_v3c_ad | Array | M | M | This component may reference a timed |
| | | | | accessor that provides the V3C atlas data |
| | | | | buffer. The atlas buffer format is defined. |
| | | | | For example, as would be understood |
| | | | | with the coded representation of |
| | | | | immersive media, scene description and |
| | | | | support for immersive media codecs in |
| | | | | scene description. |
| | | | | Future specifications of the atlas data |
| | | | | buffer format may use a different version. |
| | | | | Exactly one atlas component is present, |
| | | | | irrespective of the version. |

The _MPEG_V3C_AD object illustrated in Table 2 may have the following structure:

TABLE 2
MPEG_V3C_AD properties

| Name | Type | Default | Usage | Description |
|---|---|---|---|---|
| Version | uint8 | 1 | O | Provides a version that identifies the |
| | | | | associated configuration and atlas |
| | | | | data buffer format. The current |
| | | | | version of specification defines |
| | | | | version “1”, with the buffer formats |
| | | | | may be specified. For example, as |
| | | | | would be understood with the coded |
| | | | | representation of immersive media, |
| | | | | scene description and support for |
| | | | | immersive media codecs in scene |
| | | | | description. |
| Accessor | integer | N/A | M | This provides the index of the timed |
| | | | | accessor that provides access to the |
| | | | | atlas data buffer. |

Currently in CDAM1 of ISO/IEC 23090-14, one version (version 1) is specified which a buffer format to store common atlas data as shown Table 3.

TABLE 3
Buffer format to store common atlas data

| Field | Type | Description |
|---|---|---|
| patch_count | uint16 | provides the total number of patches. |
| for ( i=0;i<patch_count;i++ ){ | | |
| 2d_pos_x | float | specifies the x-coordinate of the top- |
| | | left corner of the patch bounding box |
| | | for the current patch. |
| 2d_pos_y | float | specifies the y-coordinate of the top- |
| | | left corner of the patch bounding box |
| | | for the current patch. |
| 2d_size_x | float | specifies the width of the current patch. |
| 2d_size_y | float | specifies the height of the current patch. |
| 3d_offset_u | float | specifies the shift to be applied to the |
| | | reconstructed patch points in the current |
| | | patch along the tangent axis. |
| 3d_offset_v | float | specifies the shift to be applied to the |
| | | reconstructed patch points in the current |
| | | patch along the bi-tangent axis. |
| 3d_offset_d | float | specifies the shift to be applied to the |
| | | reconstructed patch points in the current |
| | | patch along the normal axis. |
| patch_projection_id | uint8 | specifies the identifier of the projection |
| | | mode and the index of the normal to the |
| | | projection plane of the current patch. |
| patch_orientation | uint8 | specifies the index of the patch orientation |
| | | of the current patch. |
| lod_scale_x | uint16 | specifies the LOD scaling factor to be |
| | | applied to the tangent axis of the current |
| | | patch. |
| lod_scale_y | uint16 | specifies the LOD scaling factor to be |
| | | applied to the bi-tangent axis of the |
| | | current patch. |
| } | | |

A generic and scalable design is beneficial to support V3C-coded content in MPEG-I Scene Description. The design supports different type of patches, and patch information. The design may also constitute the necessary information to reconstruct the volumetric visual content (e.g., a point cloud). The design may also provide information about the reconstruction processes and the V3C components. A complete design may support representing atlas metadata information in an MPEG-I scene description document, such that the atlas information can be used in combination with the decoded video components by PE 250 for reconstruction operations.

The described system and method present a generic design to support V3C/V-PCC content. The system and method include the semantics as well as binary representation for decoded V3C/V-PCC media data in the form of buffers which may be used by PE 250 for reconstruction and rendering. The system and method may require definition at two stages: data representation and semantics description. Both the data representation as well as their semantics may be defined in a new glTF extension which is referred to in this document as the MPEG_V3C extension.

The proposed system and method distribute the processing of the V3C content between the MAF and PE 250, where MAF 210 performs the operations required for conformance point A 410, as defined in the ISO/IEC 23090-5 specification, in addition to nominal format conversion and PE 250 performs the 3D reconstruction processes related to conformance point B 420 (see Annex A in ISO/IEC 23090-5).

The data representation of the different components of V3C/V-PCC is important to identify the formats of the different components.

The reconstruction process for volumetric media utilizes information from the tiles of the atlas frame. Therefore, a conversion of tile-level patch information to atlas-level patch information is necessary as presented herein. The atlas-level patch information is stored in a binary buffer. Specific information such as common atlas-level patch information and application atlas-level patch information and other relevant information presented herein can be retrieved by defining different accessors to the buffer. Each accessor points to the same binary buffer with a different bufferView. Each bufferView may have a different binary offset and different binary length to access each sub-block in the buffer data. Each sub-block in the binary block stores a definite length of scalar values.

For example, the block ToPatch information block may store an array of scalar values of length equal to the total number of patch packing blocks. The total number of patch packing blocks can be determined from equations (1) and (2) in the ISO/IEC 23090-5 and set forth below for convenience.

$$AtlasBlockToPatchMapWidth = ( asps\_frame \_width + offset ) / PatchPackingBlockSize \qquad Eq . ( 1 )$$

$$AtlasBlockToPatchMapHeight = ( asps\_frame \_height + offset ) / PatchPackingBlockSize \qquad Eq . ( 2 )$$

Typically, asps_frame_height and asps_frame_width may be read by an atlas decoder during the decoding process. Therefore, MAF 210 can compute the total number of patch packing blocks in an atlas frame. The total number of patches in an atlas frame is retrieved using the TotalNumberOfPatches sub-block in the atlas data buffer frame. The TotalNumberOfPatches may also count on the total number of different patch types stored in an atlas frame. Similarly, the binary sub-block storing common patch parameters may store sixteen defined parameters for each patch in an array of scalar values. Therefore, the total number of parameters stored in this array equals the total number of patches in an atlas frame multiplied by sixteen. PE 250 may, therefore, implement a logic for an atlas data reader which is able to read the data from the atlas binary buffer effectively (using information retrieved from multiple accessors). These patch parameters are stored in the following order.

TABLE 4
Ordering of common patch parameters
Common patch parameters

PatchInAuxVideo
PatchType
Patch2dSizeX
Patch2dSizeY
Patch2DPosX
Patch2DPosY
Patch3dOffsetU
Patch3dOffsetV
Patch3dOffsetD
Patch3dRangeD
PatchProjectionID
PatchOrientationIndex
PatchLODScaleX
PatchLODScaleY
PatchRAWPoints
PatchEOMPatchCount

FIG. 5 illustrates an example Atlas data representation 500 for patch type PROJECTED and PLR enabled at patch level. FIG. 5 presents an example for atlas-level patch information data 510 for an atlas frame. Each sub-block in the atlas data can be accessed through a dedicated accessor hereinbelow. Atlas data representation 500 includes BlockToPatch information 510, total number of patches 530, common patch parameters 540, AtlasPlrdLevel 550, AtlasPlrdPresentFlag 560, and AtlasPlrdMode 570.

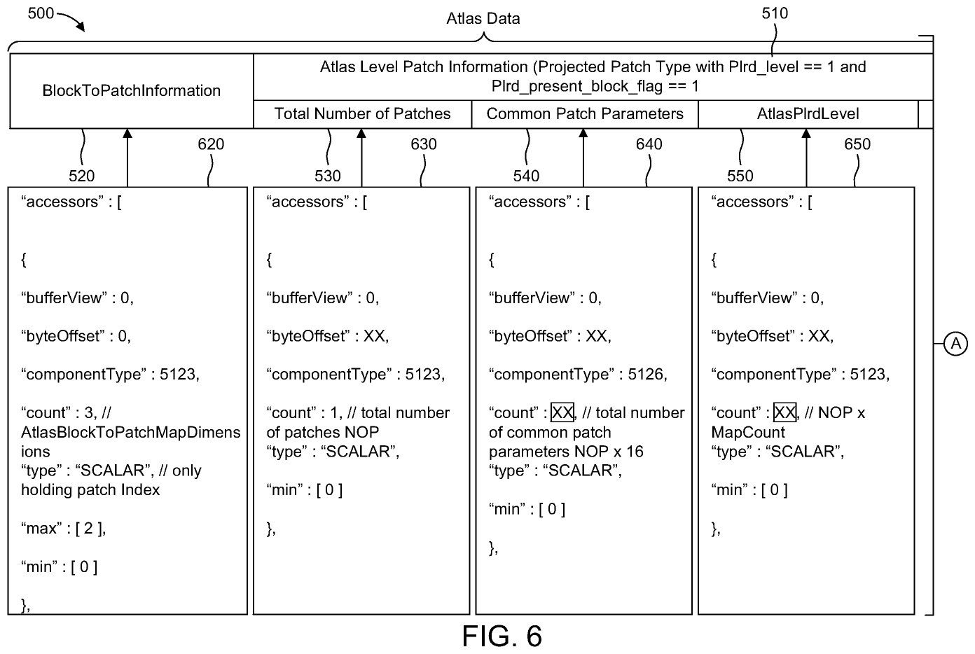

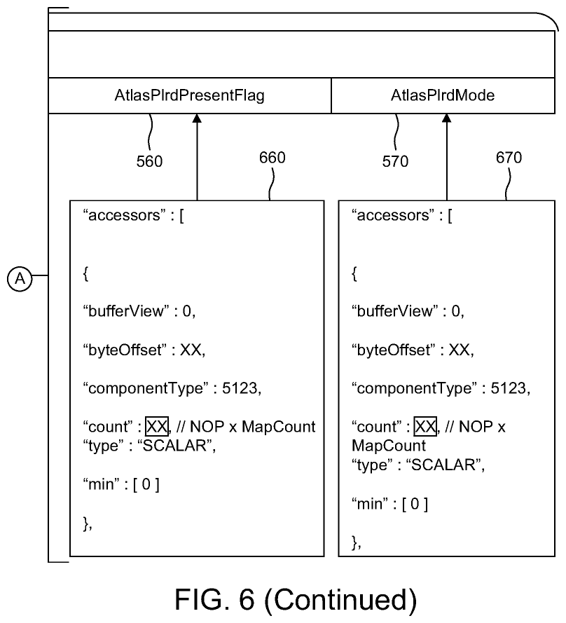

FIG. 6 illustrates multiple accessors accessing different sub-blocks in atlas binary data. FIG. 6 presents an example with multiple accessors each provides access to different sub-block in an atlas data. FIG. 6 illustrates this information starting with atlas data representation 500 of FIG. 5. Each sub-block of the atlas data is provided with an accessor. For example, BlockToPatch information 510 is identified with the accessor 620, total number of patches 530 is identified with the accessor 630, common patch parameters 540 is identified with the accessor 640, AtlasPlrdLevel 550 is identified with the accessor 650, AtlasPlrdPresentFlag 560 is identified with the accessor 660, and AtlasPlrdMode 570 is identified with the accessor 670.

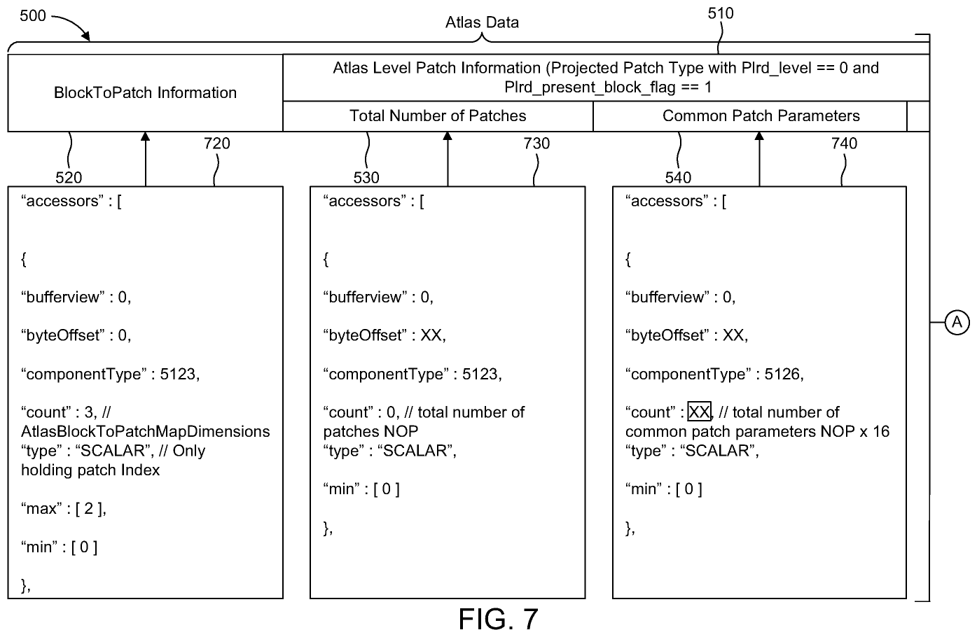

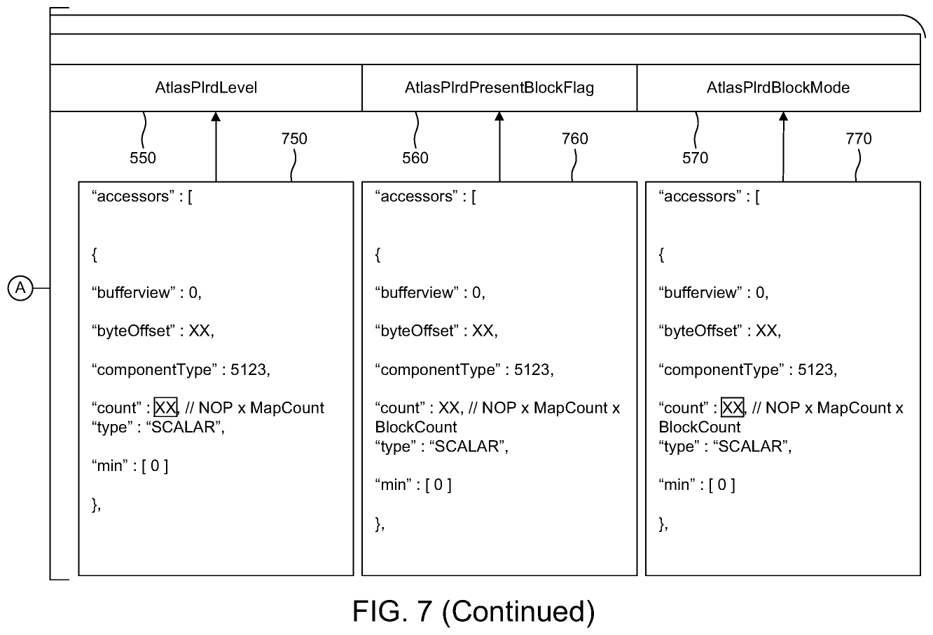

FIG. 7 illustrates an Atlas data representation with patch type PROJECTED and PLR information is available at block level. FIG. 7 presents an example for atlas-level patch information data for an atlas frame where PLR information is available at the block-level instead of at the patch level as illustrated in FIG. 6. FIG. 7 illustrates this information starting with atlas data representation 500 of FIG. 5. Each sub-block of the atlas data is provided with a patch type PROJECTED and PLR information. For example, BlockToPatch information 510 is identified with patch type PROJECTED and PLR information 720, total number of patches 530 is identified with patch type PROJECTED and PLR information 730, common patch parameters 540 is identified with patch type PROJECTED and PLR information 740, AtlasPlrdLevel 550 is identified with patch type PROJECTED and PLR information 750, AtlasPlrdPresentFlag 560 is identified with patch type PROJECTED and PLR information 760, and AtlasPlrdMode 570 is identified with patch type PROJECTED and PLR information 770.

Therefore, depending on the type of patch and appropriate flags which determine the information available for the patch, the structure of the atlas data in the binary buffer may differ. However, the means to access the data from the atlas binary buffer remains the same, i.e., using accessor where each accessor provides access to an array of scalar values whose length is determined by total number of parameters. In case the binary data is timed (i.e., the media is dynamic), a timed-accessor may be used. A timed accessor, described hereinabove, provides the means to access binary buffers which are dynamic and whose properties may change over time. In case of partial access, where only some tiles of the V3C content are required, MAF 210 is responsible for requesting the relevant/target tiles. However, as the notion of tiles is completely absent from the atlas data stored in the buffer, the same design principle of atlas data access is applicable when only partial content is retrieved. In case the content is MIV, the different number of views and per-view parameters will be provided in the atlas frame. The view parameters for each view are stored alongside other atlas information(s) in the atlas buffer.

A set of accessors (of FIG. 6) provide the means for accessing patch-specific information for each of the patches in an atlas frame whilst referring to a single binary buffer element. A single buffer may be referenced by a set of bufferViews and each bufferView may have its own glTF accessor element. The use of accessors enables PE 250 to access all the information associated with the patches contained in a decoded atlas frame.

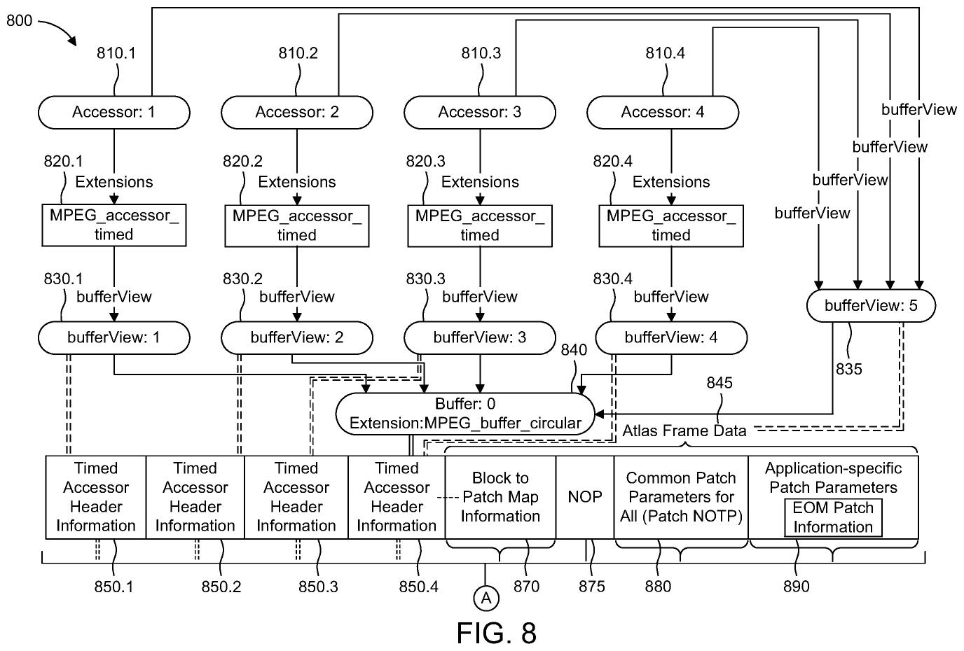

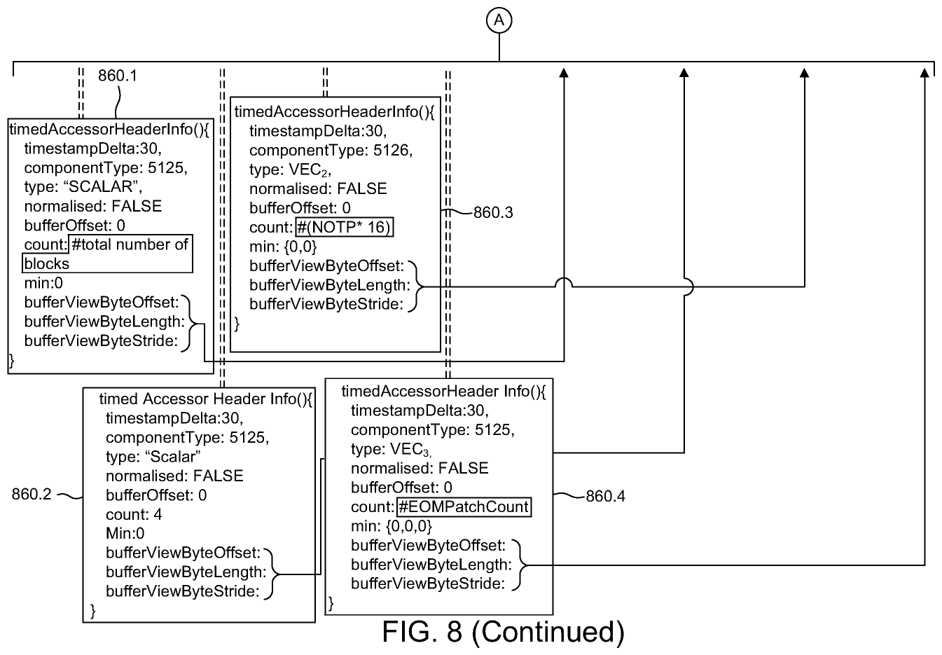

FIG. 8 illustrates the representation 800 of sub-blocks and how to read atlas data. The sub-blocks may contain V3C atlas data which correspond to semantics in and n some embodiments described below, the sub-blocks may contain V3C atlas data which correspond to semantics in Table 16. In the alternative approach, the use of accessor object is minimized (specifically for the application-specific information) and thus the relevant data is compacted.

The following description details on how the atlas data is compacted. The sub-block of data storing the BlockToPatchMap information may follow a defined structure. The data stores patch index for each block of the atlas frame. Therefore, the properties of the accessor for the blocktoPatchMap information are: components: unsignedInt or float, type: scalar, and count: total number of blocks in the atlas frame.

The sub-block which represents the number of the patches may store total number of patches as well as total number of application specific patches. The properties of the accessor are: componentType: unsignedInt, type: scalar, and count: total number of patches+total number of (projected patches+eom patches+RAW patches).

The sub-block which stores the common patch parameters information may store patch parameters per patch in a list. The common patch parameter per patch may be ordered. The data can be stored either as a scalar entity or vec2 entity. In case, scalar type is chosen the data may follow an implicit increasing order of the patch index as well as patch parameters. In case, vec2 type is chosen the data may be stored as presented in Table 1. The properties of the timed-accessor header information are: componentType: unsignedInt, type: scalar/vec2, count: total number of patches*16.

As illustrated in FIG. 8, representation 800 includes a plurality of accessor (collectively MPEG accessor timers 810) including accessor 1 810.1, accessor 2 810.2, accessor 3 810.3 and accessor 4 810.4, although any number of accessors may be used. A plurality of MPEG accessor timers (collectively MPEG accessor timers 820) including MPEG accessor timer 820.1 for accessor 1 810.1, MPEG accessor timer 820.2 for accessor 2 810.2, MPEG accessor timer 820.3 for accessor 3 810.3, MPEG accessor timer 820.4 for accessor 4 810.4. A plurality of buffers (collectively buffers 830) are then fed, including buffer 1 830.1 from MPEG accessor timer 820.1, buffer 2 830.2 from MPEG accessor timer 820.2, buffer 3 830.3 from MPEG accessor timer 820.3, and buffer 4 830.4 from MPEG accessor timer 820.4. Other buffers, such as buffer 835, may be fed directly by the accessors 810, MPEG accessor timers 820, for example.

A buffer 840 (or plurality of buffers) may be fed by buffers 830 and buffer 835. Representation 800 includes a plurality of timed accessor header information blocks 850 including timed accessor header information block 850.1 fed by buffer 830.1, timed accessor header information block 850.2 fed by buffer 830.2, timed accessor header information block 850.3 fed by buffer 830.3, and timed accessor header information block 850.4 fed by buffer 830.4 and buffer 840. Timed accessor header information 850 may then feed descriptors 860. For example, timed accessor header information 850.1 feed descriptor 860.1, timed accessor header information 850.2 feed descriptor 860.2, timed accessor header information 850.3 feed descriptor 860.3, and timed accessor header information 850.4 feed descriptor 860.4.

Buffer 835 may provide information to atlas frame data 845 which may include block to patch map information 870, NOP 875, common patch parameters 880, and application specific patch parameters 890. Descriptors 860 may be fed back to atlas frame data 845 including block to patch map information 870, NOP 875, common patch parameters 880, and application specific patch parameters 890.

TABLE 5
Storing common patch parameters as vec2

| Patch index | Patch parameters |
|---|---|
| 1 | #AtlasPatchInAuxVideo_Patch1 |
| 1 | #AtlasPatchType_Patch1 |
| 1 | #AtlasPatch2DSizeX_Patch1 |
| . . . | . . . |
| 2 | #AtlasPatchInAuxVideo_Patch2 |
| 2 | #AtlasPatchType_Patch1 |
| 2 | #AtlasPatch2DSizeX_Patch2 |
| . . . | . . . |

Depending on the type of patches there are additional application-specific parameters information. To store such information, the data storage is split into type of patches which is also visually represented in FIG. 6.

In case the patch type is PROJECTED, the point-local reconstruction may be stored in the atlas buffer. There may be at least two sub-block storing the PLR data depending on whether the PLR information is available on block-level or patch-level. The information related to what PLR level does each projected patch correspond to is provided in a sub-block storing the data as represented in Table 6. The corresponding accessor properties for the sub-block are: componentType: unsignedInt, type: vec2, count: number of PROJECTED patches.

### Table 6—Information about the PLR Level

TABLE 6
Information about the PLR level

| Patch Index | PLRD Level; (0 == Block level , 1 == Patch level) |
|---|---|
| 1 | 0 |
| 2 | 0 |
| 3 | 1 |
| 4 | 1 |
| 5 | 0 |

Depending upon the PLR level(s) contained in an atlas frame, there can be either information for PLR for each block in a patch or PLR information for a patch (i.e., the blocks in a patch may have the same PLR information). In case, the PLR level for a patch is identified as block-level, then a sub-block may be stored block-level PLR information as represented in Table 7. The corresponding accessor properties for the sub-block are: componentType: unsignedInt, type: vec3, count: Σ_(i=0)\hat{ }N [symbol] BlockCount[i].

### Table 7—Information for Block-Level PLR

TABLE 7
Information for Block-level PLR

| Patch Index | PLRD Present Block Flag | PLRD block mode |
|---|---|---|
| 1 | 0 | 0 |
| 1 | 1 | #mode |
| 2 | 1 | #mode |
| 2 | 1 | #mode |
| 5 | 0 | |
| 5 | 1 | #mode |

In case, the PLR level for a patch is identified as patch-level, then a sub-block may be stored patch-level PLR information as represented in Table 8. The corresponding accessor properties for the sub-block are: componentType: unsignedInt, type: vec3, and count: number of patch-level PLR patches.

TABLE 8
Information about patch-level PLR data

| Patch Index | PLRD Present Flag | PLRD mode |
|---|---|---|
| 3 | 1 | #mode |
| 4 | 0 | 0 |

In case the patch type if EOM, the information related to EOM patch may be stored as represented in Table 9. The corresponding accessor properties for the sub-block are: componentType: unsignedInt, type: vec3, and count: Σ_(i=0)\hat{ }TOEP [symbol] patchEOMPatchCount[i].

TABLE 9
Information about EOM patches

| Patch Index | EOM Points Count | Associated Patch Index |
|---|---|---|
| 6 | #Point1 | 10 |
| 6 | #Point2 | 10 |
| 7 | #Point1 | 11 |
| 7 | #Point2 | 12 |
| | #Point1 | 9 |

In case the atlas frame stores MIV related data, there may be a list of camera view which correspond to each patch. MIV views are stored as represented in Table 10 or Table 11. The corresponding accessor properties for the sub-block are: componentType: unsignedInt, type: vec2, and count: number of views (NOV)*(27+November).

TABLE 10
Information about MIV views (type: vec2)

| View Index | View parameters |
|---|---|
| 1 | #ViewPosX[1] |
| 1 | #ViewPosY[1] |
| 1 | #ViewPosZ[1] |
| . . . | |
| 2 | #ViewPosX[2] |
| 2 | #ViewPosY[2] |
| . . . | |

The corresponding accessor properties for the sub-block are: componentType: unsignedInt, type: scalar, and count: 1+number of views (NOV)*(27+November).

TABLE 11
Information about MIV views (type: scalar)
View parameters

#NOV
#ViewPosX[1]
#ViewPosY[1]
#ViewPosZ[1]
. . .
#ViewPosX[2]
#ViewPosY[2]
. . .

MIV extends the application-specific patch parameters information as well (see section 9.2.7.3.3 in ISO/IEC 23090-12). Therefore, there may be additional sub-blocks storing the information. Each patch corresponds to a view index. Therefore, for a patch list, view index per-patch is stored. The corresponding accessor properties for the sub-block is: componentType: unsignedInt, type: vec2/scalar, and count: total number of patches.

In case the patch type is PROJECTED, additional parameters are provided as represented in Table 12. The MIV projected parameters per patch may be stored in an order. The corresponding accessor properties for the sub-block may be: componentType: unsignedInt, type: vec2/scalar, and count: total number of PROJECTED patches*5.

TABLE 12
Information about MIV PROJECTED patch parameters

| Patch Index | MIV PROJECTED parameters |
|---|---|
| 1 | #entityID |
| 1 | #depthOccThres |
| 1 | #offset1 |
| 1 | #offset2 |
| 1 | #offset3 |
| 2 | #EntityID |
| . . . | |

The V3C video-coded components such as occupancy, geometry, and attributes are typically decoded using regular video decoders such as H.264, HEVC, or VVC. The decoded frames from each V3C component may also be subjected to additional post-processing processes (see Annex B ISO/IEC 23090-5). The final decoded frames for the V3C components are then made available to PE 250 as video textures.

In the context of scene description, the decoded video textures are signaled as texture objects in the textures array. The video texture objects are texture objects that include an MPEG_texture_video extension which extends the capabilities of a texture element to support video textures. A video texture provides access to the decoded video texture as well as associated information. A video texture may be processed to represent the video texture in a nominal format which may be used by PE 250 for 3D reconstruction by performing post-processing operations on the decoded V3C video textures. The format of the decoded video texture may be in the 4:4:4 chroma sub-sampling format. In one configuration, the nominal chroma format is 4:4:4 since it is important to have a representation that match all samples in the decoded V3C images to the reconstructed 3D points. Hence, the video textures may be in the YCbCr or RGB formats. The decision on which color format is used for the video textures (i.e., RGB or YCbCr) is application/implementation-specific.

A new scene-level extension, namely MPEG_V3C, may signal information relevant to each V3C component of the V3C media objects present in the scene and describe the textures and buffers that may hold the decoded video frames and atlas data for these media objects. The extension lists an array of V3C media objects. Each item in the array contains information about the components of the corresponding V3C media object signaled using four main properties: V3C_OCCUPANCY—representing information related to the occupancy component, V3C_GEOMETRY—representing information related to geometry component, V3C_ATTRIBUTE—representing information related to attribute components, and V3C_ATLAS—representing information related to the atlas component of the V3C content. A V3C content may include more than one atlas and each atlas may be associated with its own geometry, occupancy, and set of attribute components.

In a glTF file, “MPEG_V3C” extension may be added to the “extensionRequired” and “extensionUsed” top-level glTF property. This may include:

```
“extensionsRequired”: [
  “MPEG_V3C”
],
“extensionsUsed”: [
  “MPEG_V3C”
],
```

The V3C syntax may be a top-level extension. A node in the scene with the MPEG_V3C extension may refer to an index in the array defined in MPEG_V3C element in the scene-level extensions. An example of a pseudo glTF file that utilizes the MPEG_V3C extension is given below and provides the syntax for representing V3C content. This syntax for representing V3C content includes:

```
“extensions”: {
  “MPEG_V3C”: {
  “objects”: [ {
    “V3C_OCCUPANCY”: [{
      “index”: 1, // <− index to a video texture
    }],
    “V3C_GEOMETRY”: [{
      “index”: 2 // <− index to a video texture
      }
    }],
    “V3C_ATTRIBUTE”: [
      {
        “type”: 0, // <− texture attribute
        “index”: 3 // <− index to a video texture
      },
      {
        “type”: 2, // <− transparency attribute
        “index”: 4 //<− index to a video texture
      }
    ],
    “V3C_ATLAS”: [{
      “blockSize”: 16, //<− patch blocking size
      “blockToPatchInformation”: 111, //<− accessor
      “totalPatches”: 112, //<− accessor
      “commomPatchParameters”: 113, //<− accessor
      “patchInformation”: [
        {
          “type”: “PROJECTED”,
          “PLRDLevel”: 114, //<− accessor
          “PLRDPresentBlockFlag”: 115, //<− accessor
          “PLRDBlockMode”: 116, //<− accessor
          “PLRDPresentFlag”: 120, //<− accessor
          “PLRDMode”: 121 //<− accessor
        },
        {
          “type”: “EOM”,
          “patchEOMPoints”: 117, //<− accessor
          “patchAssociatedPatchIndex”: 118 //<− accessor
        },
        {
          “type”: “RAW”,
          “numberRAWPoints”: 119 //<− accessor
        }
      ]
    }]
  }]
}
},
“nodes”: [
  {
    “translation”: [0.0, 0.0, 0.5],
    “extension”: {
      “MPEG_object”: {
  object: 0 //<− index in the MPEG_V3C array
}
    }
  }
]
```

In case asps_map_count_minus1>0, that means there are more than one map present in the atlas frame. In such a case, multiple PROJECTED patch entries may be described in the V3C_ATLAS property of MPEG_V3C.

```
“patchInformation”: [{
    “type”: “PROJECTED”,
    “mapIndex”: 0, // <− map index value
...
  },{
    “type”: “PROJECTED”,
    “mapIndex”: 1, // <− map index value
...
  }]
```

The V3C syntax may be a mesh-level extension. As per the glTF specification, the accessors referred by the attributes in mesh.primitives store specified attribute data for vertices of the mesh. The accessors to each attribute in a mesh.primitive may store per-vertex data and therefore having the same value for the count property for each attribute's accessors. For example, in the following pseudo glTF example, a triangle mesh is described having POSITION, and NORMAL attributes. Each attribute points to an accessor. The accessors provide the information on how to read the data for attributes. To describe a triangle, three vertices are needed. The accessor at index 1 stores POSITION data for the three vertices. The accessor at index 2 stores NORMAL data for the three vertices. The count property for both the accessor at index 1 and index 2 is same.

```
{
  ...
  “nodes” : [
    {
      “mesh” : 0
    },
  ],
  “meshes” : [
    {
      “primitives” : [ {
        “attributes” : {
          “POSITION” : 1,
          “NORMAL” : 2
        },
        “indices” : 0
      }]
    }
  ],
...
  “accessors” : [
    {
      “bufferView” : 0,
      “byteOffset” : 0,
      “componentType” : 5123,
      “count” : 3,
      “type” : “SCALAR”,
      “max” : [ 2 ],
      “min” : [ 0 ]
    },
    {
      “bufferView” : 1,
      “byteOffset” : 0,
      “componentType” : 5126,
      “count” : 3,
      “type” : “VEC3”,
      “max” : [ 1.0, 1.0, 0.0 ],
      “min” : [ 0.0, 0.0, 0.0 ]
    }, {
      “bufferView” : 1,
      “byteOffset” : 36,
      “componentType” : 5126,
      “count” : 3,
      “type” : “VEC3”,
      “max” : [ 0.0, 0.0, 1.0 ],
      “min” : [ 0.0, 0.0, 1.0 ]
    }
  ],
  “asset” : {
    “version” : “2.0”
  }
}
```

glTF specification allows to define new attribute types to store application-specific data for a mesh. However, such new attributes may obey the data representation rules of glTF, i.e. the accessors for application-specific attribute must define per-vertex data and each attribute's accessor must have the same count value. To represent a V3C as a mesh in glTF, the syntax elements used to describe V3C may not break the core data representation concepts of glTF meshes. For example, defining a mesh.primitive.attribute which does not store per-vertex data for the all the vertices of the mesh, such a glTF file should be considered invalid.

Since V3C is different kind of compression scheme for 3D objects i.e. projection based, it may be considered as a candidate used to compress 3D object i.e. point cloud in glTF.meshes. An extension to mesh.primitives can be provided. This extension design is similar to the design used in defining “KHR_draco_mesh_compression”. In case of V3C, an extension may describe the decoded but not reconstructed V3C content. Once the reconstruction is performed, the 3D object is in its true form i.e., point cloud. Representation of point clouds with glTF.mesh fits the mesh definition and obeys the general constructs to define new attributes. These new attributes may be V3C specific attributes such as “REFLECTANCE”, “MATERIAL_ID”, etc.

Therefore, a syntax of the V3C object can be provided as an extension to mesh in a scene description file. An extension to a mesh object is provided. The extension is specific to object coded with V3C compression scheme. The presentation client is equipped with graphic processing unit (GPU). The glTF loader may parse the glTF file. If the parser supports the reconstruction of V3C object and accepts the “MPEG_V3C” extension, then the glTF loader in PE 250 may process “MPEG_V3C” extension first for a mesh. The loader may load the decoded V3C data expressed by the extension. The decoded V3C data provided by the properties specified by the MPEG_V3C extension is loaded on the GPU memory. An implementation (e.g. a shader implementation) is run on the decoded V3C data to generate the final 3D reconstructed object. The logic of 3D reconstruction is facilitated using the V3C information such as atlas, geometry, occupancy. The 3D object may be further textured using the texture information with different V3C attributes. The reconstructed 3D data may be stored in separate buffers on the GPU memory. “POSITION” attribute of the primitive corresponds to the accessor storing the position of vertices of the decompressed and reconstructed 3D object, “NORMAL” attribute of the primitive corresponds to the accessor storing the normal values of vertices of the decompressed and reconstructed 3D object in “ATTR_TEXTURE” attribute of V3C content, and “COLOR” attribute of the primitive corresponds to the accessor storing the color values of vertices of the decompressed and reconstructed 3D object in “ATTR_TEXTURE” attribute of V3C content. After the 3D reconstruction, the 3D object is in its true form i.e. point cloud. Therefore, mesh.primitive.attribute express the 3D object with attribute accessors with per-vertex data. Hence, the count property for each mesh.primitive.attribute may be the same. There may be other attributes such as “_REFLECTANCE”, “_MATERIAL_ID”, “_TRANSPARENCY”, etc. which correspond to the different V3C attribute types defined for each vertex of the 3D object.

A mesh.primitive.extension is named “MPEG_V3C”. The extension refers to the decoded data of a V3C object. Each V3C component is provided by properties in the MPEG_V3C extension.

The syntax of the extension is presented below.

```
“meshes” : {
  “primitives” : [
    {
      “attributes” : {
        “POSITION” : 11, // <− reconstructed vertices positions
        “NORMAL” : 12, // <− reconstructed vertex normals
        “COLOR_0”: 13 // <− reconstructed vertex colors
      },
      “mode” : 0,
      “extensions” : {
        “MPEG_V3C” : {
          “V3C_OCCUPANCY”: {
            “index” : 1 // <− texture
          },
          “V3C_GEOMETRY” : {
            “index”: 2 // <− texture
          },
          “V3C_ATTRIBUTE” : {
            “index”: 3, // <− texture
            “type”: 4 // <− v3c attribute type
          },
          “V3C_ATLAS”: {
            “blockSize”: 16, // <− block size
            “BlockToPatchMap”: 111, // <− accessor
            “NumberOfPatches”: 112, // <− accessor
            “CommomPatchParameters”: 113, // <− accessor
            “PLRLevel”: 114, // <− accessor
            “BlockPLRD”: 115, // <− accessor
            “PatchPLRD”: 116, // <− accessor
            “EOMPatchInfo”: 117 // <− accessor
          }
        }
      }
    }
  ]
}
```

Since, the extension is expressed at the mesh-level. A node referencing a mesh with extension “MPEG_V3C” may put the object in scene graph for rendering.

MIV is a special case of V3C representation in glTF2.0 as meshes. A glTF loader may store the viewing space boundaries in the accessor referred by the “POSITION” attribute of a mesh. The viewing space boundaries are conveyed by the MIV bitstream. The texture of the MIV content is directly passed to the renderer based on different camera views in the viewing space. The information on the camera views is stored in the atlas property of the MPEG_V3C extension.

There may be multiple atlases multiplexed in a V3C bitstream. Each atlas may have its corresponding atlas data and video-coded components such as geometry, attribute and occupancy. Thereby, to define the support for multiple atlases for MPEG_V3C extension, there are two approaches which could be followed. The two approaches are detailed in below.

One approach includes outer-inner array for each V3C component. To describe the support for multiple atlases, each property in the MPEG_V3C extension provides an outer array. The outer array length may be equal to number of atlases for a V3C object. The components with maps such as geometry, occupancy and attribute further refer to an array i.e., inner array with each array item referring to a specific map. The properties in the inner array correspond to component-specific data reference e.g., for video-coded data, the index of the corresponding video texture is referred. Similarly for atlas data in V3C_ATLAS, different accessors refer to their respective buffer which store the respective atlas data for an atlas item in the array. Each item in the outer array with index i of a component may have the corresponding component for the same atlas in other properties at index i. The index i may be the atlas ID. For example, an item with index i in V3C_ATLAS may correspond to the atlas data for an atlas at index i. The corresponding video-coded component for the same atlas such as attribute, is referred by the item at index i in V3C_ATTRIBUTE property. Additional to explicitly mentioned, the atlasID for each atlas in the MPEG_V3C extension, an additional property named ‘atlasID’ is introduced. atlasID is an array of integer values. Each integer value refers to the vpc_atlas_id as shown above for each atlas in a V3C bitstream.

Using this approach, a syntax description is presented below.

```
“meshes” : {
  “primitives” : [
    {
      “attributes” : {
          “POSITION” : 11, // <− reconstructed vertices positions
          “NORMAL” : 12, // <− reconstructed vertex normals
          “COLOR_0”: 13 // <− reconstructed vertex colors
      },
      “mode” : 0,
      “extensions” : {
          “MPEG_V3C” : {
        “atlasID”: [ 1 ],
            “V3C_OCCUPANCY”: [ [{
              “index”: 1, //<− index to a video texture
            }]] ,
            “V3C_GEOMETRY”: [ [{
              “index”: 2 //<− index to a video texture
            }]] ,
            “V3C_ATTRIBUTE”: [ [{
              “type”: 0, // <− texture attribute
              “index”: 3 // <− index to a video texture
            },
            {
              “type”: 2, // <− transparency attribute
              “index”: 4 //<− index to a video texture
            }] ],
            “V3C_ATLAS”: [{
              ...
            }]
          }
      }
    }
  ]
}
```

Another exemplary approach includes an array of atlases. Another approach to describe the support for multiple atlases is to define a new property under ‘MPEG_V3C’ extension named ‘atlases’. ‘atlases’ is an array of components corresponding to an atlas as shown in Table 13. The length of atlases array may be equal to number of atlases for a V3C object. The properties for an object in the atlases array describe the atlas data component and corresponding video-coded components such as attribute, occupancy, and geometry for a V3C object.

TABLE 13
MPEG_V3C extension property

| Name | Type | Default | Usage | Description |
|---|---|---|---|---|
| atlases | array(object) | N/A | M | provides an array of atlases |
| | | | | for the V3C object, with |
| | | | | each item in the array |
| | | | | defining the data for each |
| | | | | component for a single |
| | | | | atlas as well as the |
| | | | | relevant atlas data. |

An object in the ‘atlases’ array correspond to components for one atlas frame of a V3C object. The object may have an identifier named ‘atlas_ID’ which store the same integer value as vps_atlas_id. Using this approach, a syntax description is presented below.

```
“meshes” : {
  “primitives” : [
    {
      “attributes” : {
        “POSITION” : 11, // <− reconstructed vertices positions
        “NORMAL” : 12, // <− reconstructed vertex normals
        “COLOR_0”: 13 // <− reconstructed vertex colors
      },
      “mode” : 0,
      “extensions” : {
        “MPEG_V3C” : {
            “atlases”: [ {
          “atlas_ID”: 1, //<− atlas ID
              “V3C_OCCUPANCY”: [{
                “index”: 1, //<− index to a video texture
              }],
              “V3C_GEOMETRY”: [{
                “index”: 2 //<− index to a video texture
              }],
              “V3C_ATTRIBUTE”: [{
                “type”: 0, // <− texture attribute
                “index”: 3 // <− index to a video texture
              },
              {
                “type”: 2, // <− transparency attribute
                “index”: 4 //<− index to a video texture
              }],
              “V3C_ATLAS”: [{
                ...
              }]
            }]
        }
      }
    }
  ]
}
```

The semantics for MPEG_V3C extension at scene-level are described in Table 14 below.

TABLE 14
Semantics for MPEG-V3C Extensions

| Name | Type | Default | Usage | Description |
|---|---|---|---|---|
| objects | Array | [ ] | — | Array of V3C objects |

The semantics for atlas data are described in Table 15 and Table 16.

TABLE 15
V3C atlas semantics

| Name | Type | Default | Usage | Description |
|---|---|---|---|---|
| PatchBlockSize | Number | 16 | M | Describes the patch block |
| | | | | size of the atlas frame |
| BlockToPatchInformation | Number | — | M | Index in the accessor array |
| | | | | which refers to the block to |
| | | | | patch information data |
| TotalPatches | Number | — | M | Index in the accessor array |
| | | | | which holds the information |
| | | | | on number of patches |
| CommonPatchParameters | Number | — | M | Index in the accessor array |
| | | | | which holds the information |
| | | | | on common patch parameters |
| PatchInformation | Array | [ ] | M | Array of patch types and |
| | | | | their respective information |

TABLE 16
V3C atlas patch information semantic

| Name | Type | Default | Usage | Description |
|---|---|---|---|---|
| type | Number | — | M | Describes the type of patch |
| PLRDLevel | Number | — | O | Index in the accessors array which holds |
| | | | | the information whether the PLR is at block |
| | | | | level or patch level. |
| | | | | Only applicable if patch type is |
| | | | | PROJECTED. |
| PLRDPresentBlockFlag | Number | — | O | Index in the accessors array which holds |
| | | | | the information on presence of block level |
| | | | | PLR mode. |
| | | | | Only applicable if patch type is |
| | | | | PROJECTED. |
| PLRDBlockModeMinus1 | Number | — | O | Index in the accessors array which holds |
| | | | | the information on block level PLR mode. |
| | | | | Only applicable if patch type is |
| | | | | PROJECTED. |
| PLRDPresentFlag | Number | — | O | Index in the accessors array which holds |
| | | | | the information on presence of patch level |
| | | | | PLR Mode. |
| | | | | Only applicable if patch type is |
| | | | | PROJECTED. |
| PLRDModeMinus1 | Number | — | O | Index in the accessors array which holds |
| | | | | the information on patch level PLR mode. |
| | | | | Only applicable if patch type is |
| | | | | PROJECTED. |
| patchAssociatedPatchIndex | Number | — | O | Index in the accessors array which |
| | | | | specifies the index of the patches |
| | | | | associated EOM patches. |
| | | | | Only applicable if patch type is EOM. |
| patchEOMPoints | Number | — | O | Index in the accessors array which holds |
| | | | | the information on the number of EOM |
| | | | | coded points. |
| | | | | Only applicable if patch type is EOM. |
| numberRAWPoints | Number | — | O | Index in the accessors array which holds |
| | | | | the information on the number of raw coded |
| | | | | points. |
| | | | | Only applicable if patch type is RAW. |
| MIVViews | Number | — | O | Index in the accessors array which stores |
| | | | | the list of view parameters for each view |
| | | | | stored in the atlas data. |
| MIVViewIndex | Number | — | O | Index in the accessors array which stores |
| | | | | the view index per patch in the atlas data |
| MIVPROJParameters | Number | — | O | Index in the accessors array which stores |
| | | | | MIV PROJECTED specific patch |
| | | | | parameters |

In contrary to V3C atlas syntax defined in herein, in another embodiment, alternative syntax for V3C_atlas is possible. Depending on the type of patch (i.e., PROJECTED, EOM or RAW), additional information may be provided. For instance, an atlas frame consists of PROJECTED patches, each projected patch may have point-local reconstruction (PLR) information. Whether the PLR information for a patch is available on a block-level or patch-level is provided through ‘PLRLevel’ and corresponding PLR data is provided in ‘BlockPLRD’ and/or ‘PatchPLRD’. ‘BlockSize’ corresponds to a value of the patch packing blocking size.

The following example defines properties for the V3C atlas component of a V3C content containing PROJECTED patches as well as EOM patches. The data representation for the syntax elements is presented in Table 5, Table 6, Table 7, Table 8, Table 9, Table 10 and Table 11.

```
  {
    “extensions”: {
      “MPEG_V3C”: {
        “objects”: [{
          // ... add V3C video-coded components
          “V3C_ATLAS”: [{
```

| | |
|---|---|
| “blockSize”: 16, | // <− patch packing block size |
| “BlockToPatchMap”: 111, | // <− accessor |
| “NumberOfPatches”: 112, | // <− accessor |
| “CommomPatchParameters”: 113, | // <− accessor |
| “PLRLevel_N”: 114, | // <− accessor |
| “BlockPLRD_N”: 115, | // <− accessor |
| “PatchPLRD_N”: 116, | // <− accessor |
| “EOMPatchInfo”: 117 | // <− accessor |

```
            }]
          }]
        }
      }
}
```

In the case where asps_map_count_minus1>0, there is more than one map present in the atlas frame. In such a case, multiple PROJECTED patch entries may be described in the V3C_ATLAS property of MPEG_V3C. Therefore, PLR information for each patch can be marked with map index i.e. PLRLevel_N where N is the map index.

```
“meshes” : {
  “primitives” : [
    {
      “attributes” : {
        “POSITION” : 11, // <− reconstructed vertices positions
        “NORMAL” : 12, // <− reconstructed vertex normals
        “COLOR_0”: 13 // <− reconstructed vertex colors
      },
      “mode” : 0,
      “extensions” : {
        “MPEG_V3C” : {
          “V3C_OCCUPANCY”: {
            “index”: 1, // <− texture
          },
          “V3C_GEOMETRY” : {
            “index”: 2 // <− texture
          },
          “V3C_ATTRIBUTE” : {
            “index”: 3, // <− texture
            “type”: 4 // <− v3c attribute type
          },
          “V3C_ATLAS”: {
```

| | |
|---|---|
| “blockSize”: 16, | // <− block size |
| “BlockToPatchMap”: 111, | // <− accessor |
| “NumberOfPatches”: 112, | // <− accessor |
| “CommonPatchParameters”: 113 | // <− accessor |

```
          },
          “MPEG_V3C_CAD”: {
            “MIV_view_parameters”: 114,
          }
        }
      }
    }
  ]
}
```

Different embodiment of semantics for V3C_atlas are also contemplated. These semantics correspond to the syntax defined herein. V3C atlas information can be provided with lesser number of accessor units. Valid accessor type and component type for each property of a V3C atlas frame are defined in Table 17.

TABLE 17
Accessors for V3C atlas properties

| | | Accessor | Component | |
|---|---|---|---|---|
| Name | Usage | type(s) | type(s) | Description |
| BlockToPatchMap | M | SCALAR | Unsigned int | Store stores patch index for |
| | | | | every block in an atlas |
| | | | | frame. In case, a block is not |
| | | | | assigned with a patch index, |
| | | | | the block is assigned with |
| | | | | value 0. |
| NumberOfPatches | M | SCALAR | Unsigned int | Stores the information on |
| | | | | total of number of patches as |
| | | | | well as total number of |
| | | | | different patch types. |
| CommonPatchParameters | M | VEC2 | Unsigned int | Stores common patch |
| | | SCALAR | | parameters per patch in an |
| | | | | atlas frame. |
| PLRLevel | O | VEC2 | Unsigned int | Stores the PLRD level |
| | | | | information for each |
| | | | | PROJECTED patch type. In |
| | | | | case, the PLR level is 0, the |
| | | | | PLR information is available |
| | | | | on per block level. Else if |
| | | | | PLR level is 1, the PLR |
| | | | | information is available on |
| | | | | the patch level. |
| BlockPLRD | O | VEC3 | Unsigned int | Stores block-level PLRD |
| | | | | information for PROJECTED |
| | | | | patch type. |
| PatchPLRD | O | VEC3 | Unsigned int | Stores patch-level PLRD |
| | | | | information for PROJECTED |
| | | | | patch type. |
| EOMPatchInfo | O | VEC3 | Unsigned int | Stores application-specific |
| | | | | information related to EOM |
| | | | | patches. |
| MIVViews | O | VEC2 | Unsigned Int | Stores the list of view |
| | | Scalar | | parameters for each view |
| | | | | stored in the atlas data. |
| MIVViewIndex | O | VEC2 | unsignedInt | Stores the view index per |
| | | Scalar | | patch in the atlas data |
| MIVPROJParameters | O | VEC2 | unsignedInt | Stores MIV PROJECTED |
| | | | | specific patch parameters |

To store the application-specific information for a given patch in an atlas frame, two different approaches are described below.

First, storing application-specific information separately from common-patch parameters. To store the ‘Application-specific’ data in an atlas frame, see above, for different patch types, a JSON object is introduced which refers to accessors storing to the Application-specific data for individual patch types in the ‘MPEG_V3C’ extension. A ‘V3C_application_specific_info’ property is introduced to MPEG_V3C extension and it may have the following child properties as shown in Table 18.

TABLE 18
Definition of properties for V3C_application_specific_info in MPEG_V3C extension

| Name | Type | Default | Usage | Description |
|---|---|---|---|---|
| Projected | Integer | N/A | O | This refers to an accessor storing application specific |
| | | | | information for projected patch type |
| EOM | Integer | N/A | O | This refers to an accessor storing application specific |
| | | | | information for EOM patch type |
| RAW | Integer | N/A | O | This refers to an accessor storing application specific |
| | | | | information for RAW patch type |

The ‘V3C_application_specific_info’ property is defined as a property in the ‘MPEG_V3C’ extension at the primitive level.

```
“meshes” : {
    “primitives” : [
      {
        “attributes” : {
          “POSITION” : 11, // <− reconstructed vertices positions
          “NORMAL” : 12, // <− reconstructed vertex normals
          “COLOR_0”: 13 // <− reconstructed vertex colors
        },
        “mode” : 0,
        “extensions” : {
          “MPEG_V3C” : {
            “V3C_OCCUPANCY”: {
              “index” : 1 // <− texture
            },
            “V3C_GEOMETRY” : {
              “index”: 2 // <− texture
            },
            “V3C_ATTRIBUTE” : {
              “index”: 3, // <− texture
              “type”: 4 // <− v3c attribute type
            },
            “V3C_ATLAS”: {
```

| | |
|---|---|
| “blockSize”: 16, | // <− block size |
| “BlockToPatchMap”: 111, | // <− accessor |
| “NumberOfPatches”: 112, | // <− accessor |
| “CommonPatchParameters”: 113 | // <− accessor |
| }, | |
| “V3C_application_specific_info”: { | |
| “PROJECTED” : 114, | |
| “EOM” : 115, | |
| “RAW” : 116 | |
| } | |
| } | |
| } | |
| } | |
| ] | |
| } | |

The data representation for application-specific information for different properties store patch-type-specific information which are defined in ISO/IEC 23090-5 specification. Table 19 provides the data representation for parameters of a “PROJECTED” property in ‘V3C_application_specific_info’.

TABLE 19
Application-specific information: PROJECTED patches

| Field | Type | Description |
|---|---|---|
| projected_patch_count | uint16 | specifies the projected patch count |
| for ( int p = 0; p < projected_patch_count ; p++) { | | |
| plri_map_present | bool | specifies if the plr information is present |
| if (plri_map_present) { | | |
| plrdLevel | bool | specifies the level of PLR data for a |
| | | patch |
| if (plrLevel == 0 ) { | | |
| for ( b = 0; b < | | |
| blockCount < b++) { | | |
| plrdPresentblockflag | bool | specifies whether the PLR data is |
| | | present for a block |
| if | | |
| (plrdPresentBlock == 1) { | | |
| plrdBlockMode | uint8 | specifies the mode of PLR data for a |
| | | block |
| } | | |
| } | | |
| } else { | | |
| plrdPresentPatchFlag | bool | specifies whether the PLR data is |
| | | present for the patch |
| if | | |
| (plrdPresentPatchFlag) { | | |
| plrdPatchMode | uint8 | specifies the mode of the PLR data for |
| | | the patch |
| } | | |
| } | | |
| } | | |
| } | | |

Table 20 provides the data representation for parameters of a “PROJECTED” property in ‘V3C_application_specific_info’ for MIV ISO/IEC 23090-12 content.

TABLE 20
Application-specific information: Projected patches for MIV

| Field | Type | Description |
|---|---|---|
| projected_patch_count | uint16 | specifies the projected patch count |
| for ( int p = 0; p < projected_patch_count ; p++) { | | |
| patchViewIndex | uint8 | specifies the index in the buffer format for |
| | | the view parameter |
| patchEntityID | uint8 | specifies the patch entity ID for the current |
| | | patch |
| patchDepthOccThreshold | uint8 | specifies the threshold below with the |
| | | occupancy value is defined to be |
| | | unoccupied for the current patch |
| tilePatchAttributeOffset_1 | uint8 | specifies the offset applied to the first |
| | | component sample values of the attribute |
| | | for the current patch |
| tilePatchAttributeOffset_2 | uint8 | specifies the offset applied to the second |
| | | component sample values of the attribute |
| | | for the current patch |
| tilePatchAttributeOffset_3 | uint8 | specifies the offset applied to the third |
| | | component sample values of the attribute |
| | | for the current patch |
| } | | |

Table 21 provides the data representation for parameters of a “EOM” property in ‘V3C_application_specific_info’.

TABLE 21
Application-specific: EOM patches

| Field | Type | Description |
|---|---|---|
| eom_patch_count | uint16 | specifies the number of EOM patches |
| for ( int e = 0; e < eom_patch_count; e++ ) { | | |
| patchEOMPatchCount | uint8 | specifies the number of patches that |
| | | may be associated with the current patch |
| for ( i = 0; i < patchEOMPatchCount ; | | |
| i++ ) { | | |
| EOM_Points | uint8 | specifies the number of EOM coded |
| | | points in the patch associated with the |
| | | current patch |
| associatedPatchIndex | uint8 | specifies the index of the i-th patch |
| | | associated with the current patch |
| } | | |
| } | | |

Table 22 provides the data representation for parameters of a “RAW” property in ‘V3C_application_specific_info’.

TABLE 22
Application-specific: RAW patches

| Field | Type | Description |
|---|---|---|
| raw_patch_count | uint16 | specifies the number of RAW patches |
| for ( r = 0; r<raw_patch_count; r++) { | | |
| RAWPoints | uint8 | specifies the number of RAW coded |
| | | points in the current patch |
| } | | |
| } | | |

Second, storing application-specific information with common-patch information. Currently in CDAM1 of ISO/IEC 23090-14, one version (version 1) is specified which a buffer format to store common atlas data. This is a limitation as it does not include syntax to store PLR information, EOM patch type information, RAW patch type information, and MIV specific information. Therefore, a list of new versions of atlas buffer format are introduced in Table 23.

TABLE 23
Table of different atlas buffer format versions

| Version | Description |
|---|---|
| 1 | Atlas data with common atlas data. |
| 2 | Atlas data with common atlas data |
| | and PROJECTED patch type |
| | application-specific data for PLR information |
| 3 | Atlas data with common atlas data |
| | and EOM application-specific data |
| 4 | Atlas data with common atlas |
| | data and RAW application-specific data |
| 5 | Atlas data with common atlas |
| | data with PROJECTED patch type |
| | application-specific data for |
| | with PLR information, EOM patch type |
| | application-specific data, and |
| | RAW patch type application-specific data |
| 6 | Atlas data with common atlas data and PROJECTED patch type |
| | application-specific data for MIV information. |

Following is a series of buffer format definitions in Table 24, Table 25, Table 26, Table 27 and Table 28 for different atlas buffer format versions as specified in Table 23.

TABLE 24
Buffer atlas format for version 2

| Field | Type | Description |
|---|---|---|
| patch_count | uint16 | provides the total number of patches. |
| for ( i=0;i<patch_count;i++ ) { | | |
| 2d_pos_x | float | specifies the x-coordinate of the top-left |
| | | corner of the patch bounding box for the |
| | | current patch. |
| 2d_pos_y | float | specifies the y-coordinate of the top-left |
| | | corner of the patch bounding box for the |
| | | current patch. |
| 2d_size_x | float | specifies the width of the current patch. |
| 2d_size_y | float | specifies the height of the current patch. |
| 3d_offset_u | float | specifies the shift to be applied to the |
| | | reconstructed patch points in the current |
| | | patch along the tangent axis. |
| 3d_offset_v | float | specifies the shift to be applied to the |
| | | reconstructed patch points in the current |
| | | patch along the bi-tangent axis. |
| 3d_offset_d | float | specifies the shift to be applied to the |
| | | reconstructed patch points in the current |
| | | patch along the normal axis. |
| patch_projection_id | uint8 | specifies the identifier of the projection |
| | | mode and the index of the normal to the |
| | | projection plane of the current patch. |
| patch_orientation | uint8 | specifies the index of the patch |
| | | orientation of the current patch. |
| plri_map_present | bool | specifies if the plr information is present |
| if (plri_map_present) { | | |
| plrdLevel | bool | specifies the level of PLR data for a |
| | | patch |
| if (plrLevel == 0 ) { | | |
| for ( b = 0; b < | | |
| blockCount < b++) { | | |
| plrdPresentblockflag | bool | specifies whether the PLR data is |
| | | present for a block |
| if | | |
| (plrdPresentBlock == 1) { | | |
| plrdBlockMode | uint8 | specifies the mode of PLR data for a |
| | | block |
| } | | |
| } | | |
| } else { | | |
| plrdPresentPatchFlag | bool | specifies whether the PLR data is |
| | | present for the patch |
| if | | |
| (plrdPresentPatchFlag) { | | |
| plrdPatchMode | uint8 | specifies the mode of the PLR data for |
| | | the patch |
| } | | |
| } | | |
| } | | |
| } | | |

The calculation of blockCount is specified in function BlockCnt(xSize, ySize) in clause 8.4.7.9. of ISO/IEC 23090-5. The arguments to the function are tile patch dimensions, i.e., 2d_size_x, and 2d_size_y.

TABLE 25
Buffer atlas format for version 3 of atlas data

| Field | Type | Description |
|---|---|---|
| patch_count | uint16 | provides the total number of patches. |
| for ( i=0;i<patch_count;i++ ) { | | |
| 2d_pos_x | float | specifies the x-coordinate of the top-left |
| | | corner of the patch bounding box for the |
| | | current patch. |
| 2d_pos_y | float | specifies the y-coordinate of the top-left |
| | | corner of the patch bounding box for the |
| | | current patch. |
| 2d_size_x | float | specifies the width of the current patch. |
| 2d_size_y | float | specifies the height of the current patch. |
| 3d_offset_u | float | specifies the shift to be applied to the |
| | | reconstructed patch points in the current |
| | | patch along the tangent axis. |
| 3d_offset_v | float | specifies the shift to be applied to the |
| | | reconstructed patch points in the current |
| | | patch along the bi-tangent axis. |
| 3d_offset_d | float | specifies the shift to be applied to the |
| | | reconstructed patch points in the current |
| | | patch along the normal axis. |
| patch_projection_id | uint8 | specifies the identifier of the projection |
| | | mode and the index of the normal to the |
| | | projection plane of the current patch. |
| patch_orientation | uint8 | specifies the index of the patch |
| | | orientation of the current patch. |
| EOMPatchCount | uint8 | specifies the number of patches that |
| | | may be associated with the current patch |
| EOMPoints | uint8 | specifies the number of EOM coded |
| | | points in the patch associated with the |
| | | current patch |
| AssociatedPatchIndex | uint8 | specifies the index of the i-th patch |
| | | associated with the current patch |
| } | | |

TABLE 26
Buffer atlas format for version 4 of atlas data

| Field | Type | Description |
|---|---|---|
| patch_count | uint16 | provides the total number of patches. |
| for ( i=0;i<patch_count;i++ ) { | | |
| 2d_pos_x | float | specifies the x-coordinate of the top-left |
| | | corner of the patch bounding box for the |
| | | current patch. |
| 2d_pos_y | float | specifies the y-coordinate of the top-left |
| | | corner of the patch bounding box for the |
| | | current patch. |
| 2d_size_x | float | specifies the width of the current patch. |
| 2d_size_y | float | specifies the height of the current patch. |
| 3d_offset_u | float | specifies the shift to be applied to the |
| | | reconstructed patch points in the current |
| | | patch along the tangent axis. |
| 3d_offset_v | float | specifies the shift to be applied to the |
| | | reconstructed patch points in the current |
| | | patch along the bi-tangent axis. |
| 3d_offset_d | float | specifies the shift to be applied to the |
| | | reconstructed patch points in the current |
| | | patch along the normal axis. |
| patch_projection_id | uint8 | specifies the identifier of the projection |
| | | mode and the index of the normal to the |
| | | projection plane of the current patch. |
| patch_orientation | uint8 | specifies the index of the patch |
| | | orientation of the current patch. |
| RAWPoints | uint8 | specifies the number of RAW coded |
| | | points in the current patch |
| } | | |

TABLE 27
Buffer atlas format for version 5 of atlas data

| Field | Type | Description |
|---|---|---|
| patch_count | uint16 | provides the total number of patches. |
| for ( i=0;i<patch_count;i++ ) { | | |
| patch_type | uint8 | specifies the type of patch |
| 2d_pos_x | float | specifies the x-coordinate of the top-left |
| | | corner of the patch bounding box for the |
| | | current patch. |
| 2d_pos_y | float | specifies the y-coordinate of the top-left |
| | | corner of the patch bounding box for the |
| | | current patch. |
| 2d_size_x | float | specifies the width of the current patch. |
| 2d_size_y | float | specifies the height of the current patch. |
| 3d_offset_u | float | specifies the shift to be applied to the |
| | | reconstructed patch points in the current |
| | | patch along the tangent axis. |
| 3d_offset_v | float | specifies the shift to be applied to the |
| | | reconstructed patch points in the current |
| | | patch along the bi-tangent axis. |
| 3d_offset_d | float | specifies the shift to be applied to the |
| | | reconstructed patch points in the current |
| | | patch along the normal axis. |
| patch_projection_id | uint8 | specifies the identifier of the projection |
| | | mode and the index of the normal to the |
| | | projection plane of the current patch. |
| patch_orientation | uint8 | specifies the index of the patch |
| | | orientation of the current patch. |
| if (patch_type == PROJECTED) { | | |
| plri_map_present | bool | specifies if the plr information is present |
| if (plri_map_present) { | | |
| plrdLevel | bool | specifies the level of PLR data for a |
| | | patch |
| if (plrLevel == 0 ) { | | |
| for ( b = 0; b < | | |
| blockCount < b++) { | | |
| plrdPresentblockflag | bool | specifies whether the PLR data is |
| | | present for a block |
| if | | |
| (plrdPresentBlock == 1) { | | |
| plrdBlockMode | uint8 | specifies the mode of PLR data for a |
| | | block |
| } | | |
| } | | |
| } else { | | |
| plrdPresentPatchFlag | bool | specifies whether the PLR data is |
| | | present for the patch |
| if | | |
| (plrdPresentPatchFlag) { | | |
| plrdPatchMode | uint8 | specifies the mode of the PLR data for |
| | | the patch |
| } | | |
| } | | |
| } | | |
| else if (patch_type == EOM) | | |
| EOMPatchCount | uint8 | specifies the number of patches that |
| | | may be associated with the current patch |
| EOMPoints | uint8 | specifies the number of EOM coded |
| | | points in the patch associated with the |
| | | current patch |
| AssociatedPatchIndex | uint8 | specifies the index of the i-th patch |
| | | associated with the current patch |
| } | | |
| else if (patch_type == RAW) | | |
| RAWPoints | uint8 | specifies the number of RAW coded |
| | | points in the current patch |
| } | | |
| } | | |

TABLE 28
Buffer atlas format for version 6 of atlas data

| Field | Type | Description |
|---|---|---|
| patch_count | uint16 | provides the total number of patches. |
| for ( i=0;i<patch_count;i++ ) { | | |
| 2d_pos_x | float | specifies the x-coordinate of the top-left |
| | | corner of the patch bounding box for the |
| | | current patch. |
| 2d_pos_y | float | specifies the y-coordinate of the top-left |
| | | corner of the patch bounding box for the |
| | | current patch. |
| 2d_size_x | float | specifies the width of the current patch. |
| 2d_size_y | float | specifies the height of the current patch. |
| 3d_offset_u | float | specifies the shift to be applied to the |
| | | reconstructed patch points in the current |
| | | patch along the tangent axis. |
| 3d_offset_v | float | specifies the shift to be applied to the |
| | | reconstructed patch points in the current |
| | | patch along the bi-tangent axis. |
| 3d_offset_d | float | specifies the shift to be applied to the |
| | | reconstructed patch points in the current |
| | | patch along the normal axis. |
| patch_projection_id | uint8 | specifies the identifier of the projection |
| | | mode and the index of the normal to the |
| | | projection plane of the current patch. |
| patch_orientation | uint8 | specifies the index of the patch orientation |
| | | of the current patch. |
| patchViewIndex | uint8 | specifies the index in the buffer format for |
| | | the view parameter |
| patchEntityID | uint8 | specifies the patch entity ID for the |
| | | current patch |
| patchDepthOccThreshold | uint8 | specifies the threshold below with the |
| | | occupancy value is defined to be |
| | | unoccupied for the current patch |
| tilePatchAttributeOffset_1 | uint8 | specifies the offset applied to the first |
| | | component sample values of the attribute |
| | | for the current patch |
| tilePatchAttributeOffset_2 | uint8 | specifies the offset applied to the second |
| | | component sample values of the attribute |
| | | for the current patch |
| tilePatchAttributeOffset_3 | uint8 | specifies the offset applied to the third |
| | | component sample values of the attribute |
| | | for the current patch |
| } | | |

Common atlas data V3C semantics may be used in MPEG-I Scene description. The common atlas data is applicable for the entire CVS. Therefore, an additional property is defined under MPEG_V3C extension as shown in Table 29.

TABLE 29
Definition of Common atlas data property for MPEG_V3C extension

| Name | Type | Default | Usage | Description |
|---|---|---|---|---|
| _MPEG_V3C_CAD | object | N/A | CM | This object lists different properties |
| | | | | described for the Common Atlas Data in |
| | | | | ISO/IEC 23090-5. |

Legend:
For attributes: M = mandatory, O = optional, OD = optional with default value, CM = conditionally mandatory.

Some of the common atlas information which is common for the atlases in a CVS are specified in ISO/IEC 23090-12. Syntax for the MIV extension to common atlas data is specified. The syntax provides information on a list of view parameters which can be used during the rendering process (Annex H.1 in ISO/IEC 23090-12). A property named ‘MIV_view_parameters’ is specified in _MPEG_V3C_CAD object as shown in Table 30. In any future iteration, there may be more properties defined for the MPEG_V3C_CAD property.

TABLE 30
Definition of properties defined in_MPEG_V3C_CAD in MPEG_V3C extension

| Name | Type | Default | Usage | Description |
|---|---|---|---|---|
| MIV_view_parameters | integer | N/A | O | This component provides a reference |
| | | | | to a timed-accessor that contains the |
| | | | | view parameters stored in the common |
| | | | | atlas data that is applicable to a |
| | | | | sequence of frames of the V3C |
| | | | | decoded mesh primitive. |

Legend:
For attributes: M = mandatory, O = optional, OD = optional with default value, CM = conditionally mandatory.

The syntax of the MPEG_V3C_CAD is presented below.

| | |
|---|---|
| “meshes” : { | |
| “primitives” : [ | |
| { | |
| “attributes” : { | |
| “POSITION” : 11, // <− reconstructed vertices positions | |
| “NORMAL” : 12, // <− reconstructed vertex normals | |
| “COLOR_0”: 13 // <− reconstructed vertex colors | |
| }, | |
| “mode” : 0, | |
| “extensions” : { | |
| “MPEG_V3C” : { | |
| “V3C_OCCUPANCY”: { | |
| “index” : 1 // <− texture | |
| }, | |
| “V3C_GEOMETRY” : { | |
| “index”: 2 // <− texture | |
| }, | |
| “V3C_ATTRIBUTE” : { | |
| “index”: 3, // <− texture | |
| “type”: 4 // <− v3c attribute type | |
| }, | |
| “V3C_ATLAS”: { | |
| “blockSize”: 16, | // <− block size |
| “BlockToPatchMap”: 111, | // <− accessor |
| “NumberOfPatches”: 112, | // <− accessor |
| “CommonPatchParameters”: 113 | // <− accessor |
| }, | |
| “MPEG_V3C_CAD”: { | |
| “MIV_view_parameters”: 114, | |
| } | |
| } | |
| } | |
| } | |
| ] | |
| } | |

Table 31 provides the data representation for parameters of a “MIV_view_parameters” property in ‘MPEG_V3C_CAD’. These parameters are defined in Section 9.7.5.1. in ISO/IEC 23090-12.

TABLE 31
Buffer format for view parameters

| Field | Type | Description |
|---|---|---|
| numViews | uint16 | number of views |
| for ( int p = 0; p < view_count ; p++) { | | |
| viewIDToIndex | uint8 | mapping of the id associated with each view |
| viewInPaintFlag | bool | specifies if the view is an inpaint view |
| viewPosX | uint8 | specifies in scene units the x-coordinate of |
| | | the location of the view with view index equal |
| | | to v. |
| viewPosy | uint8 | specifies in scene units the y-coordinate of |
| | | the location of the view with view index equal |
| | | to v. |
| viewPosZ | uint8 | specifies in scene units the z-coordinate of |
| | | the location of the view with view index equal |
| | | to v. |
| viewQuatX | uint8 | specifies the x components for the rotation of |
| | | the view with view index equal to v using the |
| | | quaternion representation |
| viewQuatY | uint8 | specifies the y components for the rotation of |
| | | the view with view index equal to v using the |
| | | quaternion representation |
| viewQuatZ | uint8 | specifies the z components for the rotation of |
| | | the view with view index equal to v using the |
| | | quaternion representation |
| viewQuatW | uint8 | specifies the w components for the rotation of |
| | | the view with view index equal to v using the |
| | | quaternion representation |
| viewType | uint8 | specifies the projection method of the view |
| projectionPlaneWidth | uint8 | specifies the horizontal resolution of |
| | | projection plane |
| projectionPlaneHeight | uint8 | specifies the vertical resolution of the |
| | | projection plane |
| if (viewType == 0) { | | equirectangular projection |
| erpPhiMin | uint8 | specifies the minimum longitude range for an |
| | | erp projection in units of degrees |
| erpPhiMax | uin8 | specifies the maximum longitude range for an |
| | | erp projection in units of degrees |
| erpThetaMin | uint8 | specifies the minimum latitude range for an |
| | | erp projection in units of degrees |
| erpThetaMax | uint8 | specifies the maximum latitude range for an |
| | | erp projection in units of degrees |
| } else if (viewType == 1) { | | perspective projection |
| perspectiveFocalHor | uint8 | specifies in luma samples position units the |
| | | horizontal components of the focal of a |
| | | perspective projection of the view with view |
| | | index |
| perspectiveFocalVer | uint8 | specifies in luma samples position units the |
| | | vertical components of the focal of a |
| | | perspective projection of the view with view |
| | | index |
| perspectivePrincipalPointHor | uint8 | specifies in luma sample positions the |
| | | horizontal coordinates of the principal point of |
| | | a perspective projection of the view |
| perspectivePrinicipalPointVer | uint8 | specifies in luma sample positions the vertical |
| | | coordinates of the principal point of a |
| | | perspective projection of the view |
| } else if (viewType === 2) { | | orthographic projection |
| orthoHeight | uint8 | specifies in scene units the vertical |
| | | dimensions of the captured part of the |
| | | volumetric frame |
| orthoWidth | uint8 | specifies in scene units the horizontal |
| | | dimensions of the captured part of the |
| | | volumetric frame |
| } | | |
| quantizationLaw | uint8 | specifies the type of depth quantization |
| | | method of the view |
| if ( quantization_law == 0) { | | |
| normDisLow | uint8 | specifies the normalized disparity of the |
| | | lowest signalled geometry value |
| normDisHigh | uint8 | specifies the normalized disparity of the |
| | | highest signalled geometry value |
| } | | |
| occthreshold | uint8 | specifies the default occupancy threshold |
| | | used in the occupancy value extraction |
| | | process |
| root | bool | specifies whether or not the view has a parent |
| | | in the pruning graph at the encoder stage |
| if (! root) { | | |
| numParents | uint8 | specifies the number of parents of the view in |
| | | the pruning graph at the encoder stage |
| for ( int i = 0; i < numParents; | | |
| i++) { | | |
| viewParentIdx | uint8 | specifies the index of the i-th parent view in |
| | | the pruning graph at the encoder stage. |
| } | | |
| } | | |
| } | | |

Support for V3C packed video component may be included in MPEG-I scene description. Since the information about the packed video layout is available in the V3C syntax, MAF 210 may unpack the packed video stream after decoding the packed video stream. After unpacking the decoded packed video (Annex B.4. in ISO/IEC 23090-5), MAF 210 may indicate different decoded and unpacked V3C components to their relevant property in the ‘MPEG_V3C’ extension, e.g., V3C_GEOMETRY, V3C_ATTRIBUTE, and V3C_OCCUPANCY. With this approach to process packed video in V3C, no new syntax needs to be introduced to the MPEG_V3C extension, since all the V3C components are individually defined.

The occupancy and geometry components are associated with respective texture objects in the textures array through the index property whose semantics are described in Table 32.

TABLE 32
Properties for V3C_OCCUPANCY and V3C_GEOMETRY

| Name | Type | Default | Usage | Description |
|---|---|---|---|---|
| index | Number | — | M | Index in the texture array which |
| | | | | corresponds to V3C components |

For attribute components, in addition to the index of the associated texture object, the identification of the type of the attribute. Therefore, the properties associated with attribute components are as described in Table 33.

TABLE 33
Properties for V3C_ATTRIBUTE

| Name | Type | Default | Usage | Description |
|---|---|---|---|---|
| index | Number | — | M | Index in the texture array which |
| | | | | corresponds to V3C |
| | | | | attribute component |
| type | Number | — | M | Key identifier for the |
| | | | | V3C attribute type |

The key identifier represented by the value of the type property relates to a V3C attribute type as shown in Table 33. The types in Table 34 corresponds to defined attribute types in Table 14 in sub-clause 8.4.4.5 in ISO/IEC 23090-5.

TABLE 34
V3C attribute types

| Attribute values | Attribute type |
|---|---|
| 0 | Texture |
| 1 | Material ID |
| 2 | Transparency |
| 3 | Reflectance |
| 4 | Normals |
| 5 . . . 14 | Reserved |
| 15 | Unspecified |

A top-level extension is introduced herein. The extension is called “MPEG_V3C”. In an embodiment, a top-level glTF extension “MPEG_OBJECTS” can be provided. The “MPEG_OBJECTS” stores a list of objects. Each object item may be extended which describes the object. Following is an example of a pseudo-glTF file which introduces the MPEG_OBJECTS extension.

```
extensionsRequired”: [
  “MPEG_OBJECTS”,
  “MPEG_V3C”
],
“extensionsUsed”: [
  “MPEG_OBJECTS”,
  “MPEG_V3C”
],
“nodes”: [
  {
    “matrix”: { },
    “extensions”: {
      “MPEG_OBJECTS”: {
        “object” : 1
      }
    }
  }
]
“extensions”:
{
  “MPEG_OBJECTS”: {
    “objects”: [
    {
      “extensions”: {
        “MPEG_V3C”: {
        // describe the V3C components
        }
      }
    },
    {
      “extensions”: {
      “MPEG_V3C”: {
        // describe the V3C components
        }
      }
    },
    {
      “extensions”: {
      “MPEG_GPCC”: {
        // describe the GPCC components
        }
      }
    }
  ]
}
}
```

Each item in the objects array may extend to include component description for the media. For instance, the MPEG_V3C extension may describe the V3C components of the media item as shown herein. With this approach, multiple objects which are coded using MPEG codec technologies can be referred to as an object item. To attach an MPEG_OBJECTS item to node, a node-level extension is introduced to refer to an object defined in the top-level MPEG_OBJECTS.objects array. Using such a mechanism is flexible to support other kind of MPEG coded content such as G-PCC. As described in the paragraph, any content coded using MPEG technologies can be referred as an object item in the MPEG_OBJECTS.objects array. A content may be coded using any MPEG technologies such as V-PCC, G-PCC or others.

The semantics for objects of top-level MPEG_OBJECT extension is described in Table 35.

TABLE 35
Objects array in top-level MPEG_OBJECTS extension

| Name | Type | Default | Usage | Description |
|---|---|---|---|---|
| objects | Array | [ ] | — | Array of objects which |
| | | | | are coded using |
| | | | | MPEG codec technologies |

An object-level glTF extension for instance “MPEG_V3C” may contain data corresponding to different components of V3C object. The syntax of the different components for a V3C objects are present herein. The semantics for an object in node-level MPEG_OBJECTS extensions is described in Table 36.

TABLE 36
Object in node-level MPEG_OBJECTS extension

| | | | | |
|---|---|---|---|---|
| Name | Type | Default | Usage | Description |

| | | | |
|---|---|---|---|
| object | Number | — | Index to an object item in the objects array in |
| | | | MPEG_OBJECTS extension. |

In a glTF file, “MPEG_OBJECTS” and “MPEG_V3C” extensions may be added to the “extensionRequired” and “extensionUsed” top-level glTF property.

The semantics for MPEG_V3C extension at node level are described in Table 37 below.

TABLE 37
Semantics for MPEG-V3C Extensions

| Name | Type | Default | Usage | Description |
|---|---|---|---|---|
| object | Number | — | M | Index of a V3C object |
| | | | | in the objects array |
| | | | | described in |
| | | | | scene-level MPEG_V3C |
| | | | | extensions |

In addition to the MPEG_V3C extension, certain content-specific information may be aid in performing conformance point validation as described herein. A media is accessed through the MPEG_media extension defined in ISO/IEC 23090-14. Content-specific information may be provided through a JSON object in the extraParams property of an alternative in the alternatives array of V3C media object that is signaled in the MPEG_media extension. The syntax of the parameters for performing conformance point validation for a V3C content is described below:

```
“extraParams”: {
  “profile”: “#PROFILE_NAME”,
  “toolset”: “#TOOLSET_NAME”,
  “tier”: “#TIER_NAME”,
  “codecGroup”: “#CODEC_GROUP”.
  “reconstruction”: “#RECONSTRUCTURE_PROFILE ”
}
```

The semantics for the different parameters required to perform conformance point validation is described in Table 38.

TABLE 38
Extra parameters for V3C content

| Name | Type | Default | Usage | Description |
|---|---|---|---|---|
| profile | String | — | M | Describes a subset of algorithmic features and |
| | | | | limits that may be supported by all decoders |
| | | | | conforming to the profile |
| tier | String | — | M | Describes a set of limits on the values that may |
| | | | | be taken by the syntax elements of coded V3C |
| | | | | content |
| level | String | — | M | A level of a tier generally corresponds to a |
| | | | | particular decoder processing load and |
| | | | | memory capability |
| codecGroup | String | — | M | Indicates the codec group profile component to |
| | | | | which the CVS conforms to, as specified in |
| | | | | Annex A of ISO/IEC 23090-5. |
| toolset | String | — | M | Indicates the toolset combination profile |
| | | | | component to which the CVS conforms to, as |
| | | | | specified in Annex A of ISO/IEC 23090-5. |
| reconstruction | String | — | O | Describes conformance point B for the V3C |
| | | | | content, i.e. specifying the pre-reconstruction, |
| | | | | reconstruction, post-reconstruction, and |
| | | | | adaptation tools supported or recommended to |
| | | | | achieve conformance in terms of 3D |
| | | | | reconstruction. |

The information in the extraParams property is useful for decoding the bitstream as well as 3D reconstruction. The possible values for each of the parameters in Table 38 are provided in Annex A of ISO/IEC 23090-5.

Modern graphics APIs such as the Vulkan API provide a sampler structure that is associated with each texture object such that sampling operations for the YCbCr color space can be natively supported on modern GPUs. A sampler-level extension is described to sample a video texture natively in parallel processing devices such as GPUs. The format of the video texture, such as “VK_FORMAT_G8_B8_R8_3PLANE_444_UNORM” or others, may be provided in the MPEG_video_texture.format property. The syntax is provided below:

```
  “samplers”: [
      {
“extensions” : {
          “MPEG_YUV”: {
            “modelConversion”: “#709”,
            “range”: “#ITU range”,
            “chromaFilter”: “#CHROMAFILTER”,
            “xchromaOffset”: “#CHROMAOFFSET”
            “yChromaOffset”: “CHROMAOFFSET”,
          }
        }
      }
    ],
```

A texture object in the textures array may use a sampler with the “MPEG_YUV” sampler extension to provide information to PE 250 on how to sample the video texture when the sample data in the texture are in a chroma format such as YCbCr. In a glTF file, “MPEG_YUV” extension may be added to the “extensionRequired” and “extensionUsed” top-level glTF property.

Table 39 provides a description of the properties defined in the MPEG_YUV sampler extension.

TABLE 39
MPEG_YUV sampler semantics

| Name | Type | Default | Usage | Description |
|---|---|---|---|---|
| modelConversion | String | — | M | Describes the Color model component of a |
| | | | | color space |
| range | String | — | M | Describes whether color components are |
| | | | | encoded using the full range of numerical |
| | | | | values or whether values are reserved for |
| | | | | headroom and foot room. |
| chromaFilter | String | — | O | Describes filters used for texture lookups |
| components | String | — | O | Describes the order of the components |
| xchromaOffset | String | — | O | Describes the X location of downsampled |
| | | | | chroma component samples relative to the |
| | | | | luma samples |
| yChromaOffset | String | — | O | Describes the Y location of downsampled |
| | | | | chroma component samples relative to the |
| | | | | luma samples |

Table 40 provides a definition of top-level objects of MPEG_texture_video extension.

TABLE 40
Definition of top-level objects of MPEG_texture_video extension

| Name | Type | Default | Usage | Description |
|---|---|---|---|---|
| accessors | array | N/A | M | Provides a reference to the accessor(s), |
| | | | | by specifying the accessor(‘s/s’) index in |
| | | | | the accessors array, that describes the |
| | | | | buffer where the decoded timed texture |
| | | | | will be made available. |
| | | | | The accessor may have the |
| | | | | MPEG_accessor_timed extension. |
| | | | | The type, componentType, and count of |
| | | | | the accessor depend on the width, height, |
| | | | | and format. |
| | | | | In case of planar data alignment, there |
| | | | | must be at most 4 accessors (e.g., RGBA) |
| | | | | in the accessor's property. Each accessor |
| | | | | will refer to the data for a plane. |
| width | integer | N/A | M | Provides the maximum width of the |
| | | | | texture. |
| height | integer | N/A | M | Provides the maximum height of the |
| | | | | texture. |
| format | string | RGB | O | Indicates the format of the pixel data for |
| | | | | this video texture. The allowed values are: |
| | | | | RED, GREEN, BLUE, RG, RGB, RGBA, |
| | | | | BGR, BGRA, DEPTH_COMPONENT. The |
| | | | | semantics of these values are defined in |
| | | | | Table 8.3 of OpenGL specification |
| | | | | [OpenGL 4.6]. |
| | | | | Note that the number of components may |
| | | | | match the type indicated by the referenced |
| | | | | accessor. Normalization of the pixel data |
| | | | | may be indicated by the normalized |
| | | | | attribute of the accessor. |
| subSampling | string | 444 | O | Describes the sub-sampling format of the |
| | | | | source of the texture. The allowed values |
| | | | | of the sub-sampling format are 444, 420, |
| | | | | 422, 440 and 411. |
| alignment | string | INTERLEAVED | O | Specifies the data alignment of the source. |
| | | | | Three allowed values for the data |
| | | | | alignment property are INTERLEAVED, |
| | | | | PLANAR and SEMI-PLANAR. |

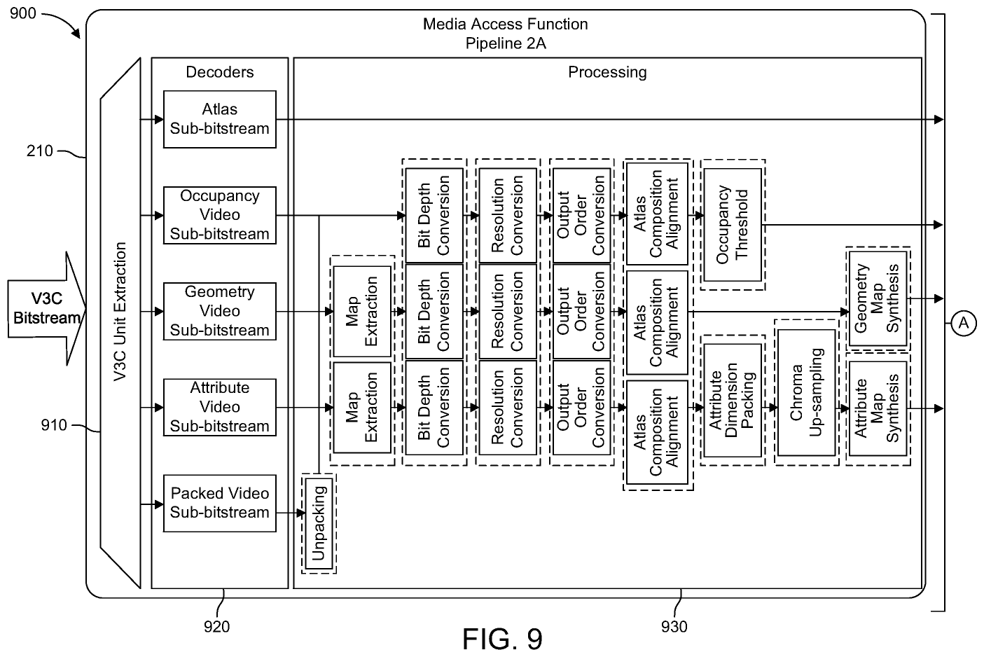

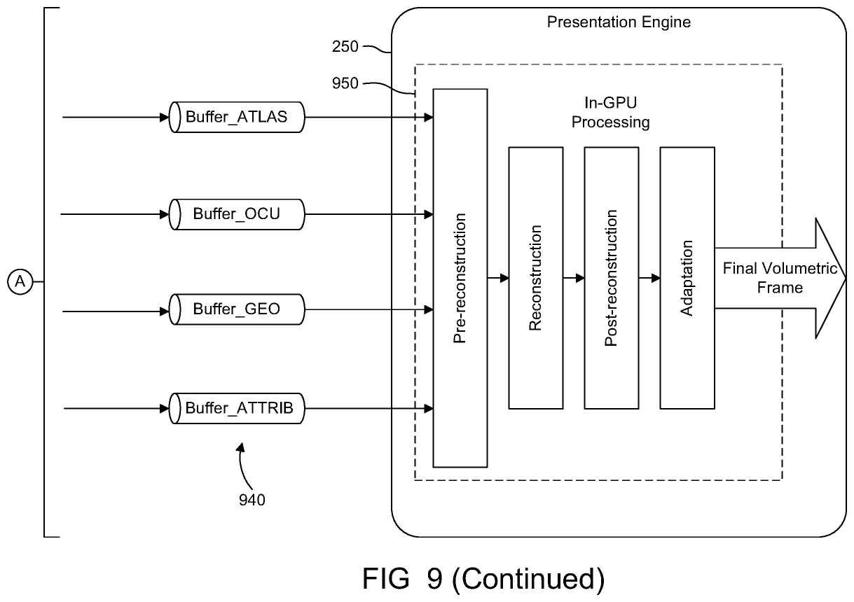

FIG. 9 illustrates a method 900 for the media workflow for V3C content described herein. The following is a description of the procedures that the MAF may use to construct a media pipeline for decoding and processing a V3C media content as well as for PE 250 to use the buffer data for reconstruction. The procedure described in this section provides information related to workflow for media pipeline (pipeline #2A 310.2a) as presented in FIG. 9.

PE(s) 250 loads a scene graph (e.g., from a glTF file). The glTF contains a node which presents a single or multiple media contents (e.g., volumetric visual media content).

The media content (e.g., volumetric visual media) is encoded. The media is encoded using V3C/V-PCC encoder.

The encoded media content is referenced through a media item in MPEG_media extension. extraParams property provides additional information about the profile, tier, and codec group.

MAF 210 initiates a media pipeline for the V3C media object. MAF 210 performs three operations: extraction 910, decoding 920 and processing 930. The V3C/V-PCC bitstream may be multiplexed. MAF 210 performs the de-multiplexing operation to extract the different V3C components encapsulated in the bitstream. The decoding of the V3C components is performed using typical video decoders such as HEVC, WVC, etc. The atlas tracks are decoded using an atlas decoder. The processing of decoded V3C components converts the decoded frames to the nominal format. The nominal format is typically 4:4:4. Additional processes may be performed such as map extraction, chroma sub-sampling, etc.

The processed V3C components are provided as video textures, where: the video textures are referenced through glTF.textures and the glTF.textures array has the MPEG_texture_video extension; the color format of video texture can be YUV/YCbCR. The texture object refers a sampler with “MPEG_YUV” extension which provides sampling information for the decoded video texture in nominal format; and YUV to RGB conversion can take place natively in a GPU using the sampler information.

The processed atlas data is provided through binary buffers 940 as described herein. The binary buffer 940 is accessed through the means of accessors. The accessors can have a MPEG_accessor_timed extension to allow for timed data.

PE 250 uses the binary buffers as well as the video textures for 3D reconstruction 950. PE 250 can also use the information related to the reconstruction profile provided in extraParams property.

MAF 210 requests the media from the server based on the views of the viewers of the scene.

Although features and elements are described above in particular combinations, one of ordinary skill in the art may appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method of using extensions for video texture formats in a Moving Pictures Expert Group (MPEG) scene description, the method comprising:
receiving information on a MPEG-I scene, wherein that information includes chroma texture;
processing the chroma texture using an extension to provide information to a presentation engine (PE) to sample video texture; and
rendering the scene using the received MPEG-I scene information and the processed chroma texture.

2. The method of claim 1, wherein the chroma texture comprises YCbCr.

3. The method of claim 1, wherein the extension is configured for chroma texture.

4. The method of claim 3, wherein the extension adapts the chroma texture.

5. The method of claim 3, wherein the chroma texture is from a modern graphics API.

6. The method of claim 1, wherein the scene is processed with a shader implementation.

7. The method of claim 1, wherein the scene is processed with a GPU implementation.

8. The method of claim 1, wherein the chroma texture is referenced through a glTF.textures array.

9. The method of claim 8 wherein the glTF.textures array has a MPEG_texture_video extension.

10. The method of claim 9, wherein the chroma texture refers to a sampler with “MPEG_YUV” extension which provides sampling information for a decoded video texture in nominal format.

11. The method of claim 1, further comprising converting YUV to RGB in a GPU using sampler information.

12. The method of claim 11, wherein the converting occurs natively.

13. The method of claim 1, further comprising requesting, via a Media Access Function (MAF), the information on the MPEG-I scene from a server based on one or more views by viewers of the MPEG-I scene.

14. A wireless transmit/receive unit (WTRU) configured to use extensions to support and allow usage of video texture formats in an MPEG-I scene description, the WTRU comprising:
a transceiver; and
a processor operatively coupled to the transceiver,
the transceiver and processor operating to:
receive information on the MPEG-I scene, wherein that information includes chroma texture;
process the chroma texture using an extension to provide information to a presentation engine (PE) to sample video texture; and
render the scene using the received MPEG-I scene information and the processed chroma texture.

15. The WTRU of claim 14, wherein the extension is configured for chroma texture.

16. The WTRU of claim 14, wherein the scene is processed with a shader implementation.

17. The WTRU of claim 14, wherein the scene is processed with is a GPU implementation.

18. The WTRU of claim 14, wherein the chroma textures are referenced through a glTF.textures array.

19. The WTRU of claim 18 wherein the glTF.textures array has a MPEG_texture_video extension.

20. The WTRU of claim 19, wherein the texture refers a sampler with “MPEG_YUV” extension which provides sampling information for a decoded video texture in nominal format.
